(19) United States
(12) Patent Application Publication
(10) Pub. No.: US 2024/0284219 A1
(43) Pub. Date: Aug. 22, 2024

(54) EXCHANGE UL MUTING PATTERN AND UL CONDITIONAL UL MUTING

(71) Applicant: QUALCOMM Incorporated, San Diego, CA (US)

(72) Inventors: Qian ZHANG, Basking Ridge, NJ (US); Muhammad Sayed Khairy ABDELGHAFFAR, San Jose, CA (US); Yan ZHOU, San Diego, CA (US)

(21) Appl. No.: 18/171,306

(22) Filed: Feb. 17, 2023

(51) Int. Cl. H04W 24/10; H04B 17/336; H04L 5/14; H04W 48/02

(52) U.S. Cl. CPC H04W 24/10; H04B 17/336; H04L 5/14; H04W 48/02

(57) ABSTRACT

A method for wireless communication at a user equipment (UE) and related apparatus are provided. In the method, a first network entity receives, from a second network entity, an uplink (UL) muting indication. The UL muting indication includes a UL muting pattern for a cross-link interference (CLI) measurement related to the first network entity and the second network entity. The first network entity further indicates, to one or more user equipment (UEs), the UL muting pattern for the one or more UEs to restrict first UL transmission to the first network entity based on the UL muting pattern. The method reduces the interferences during the measurement and transmission and improves the efficiency of wireless communication.

### TECHNICAL FIELD

The present disclosure relates generally to communication systems, and more particularly, to the UL muting pattern and UL conditional UL muting in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a first network entity. The apparatus may include memory and at least one processor coupled to the memory. Based at least in part on information stored in the memory, the at least one processor may be configured to receive, from a second network entity, an uplink (UL) muting indication including a UL muting pattern for a cross-link interference (CLI) measurement related to the first network entity and the second network entity; and indicate, to one or more user equipment (UEs), the UL muting pattern for the one or more UEs to restrict first UL transmission to the first network entity based on the UL muting pattern.

In an aspect of the disclosure, a method, a computer-readable medium, and an apparatus are provided for wireless communication at a user equipment (UE). The apparatus may include memory and at least one processor coupled to the memory. Based at least in part on information stored in the memory, the at least one processor may be configured to receive, from a network entity, a UL muting indication including a UL muting pattern; evaluate a UL muting condition associated with a UL transmission to obtain an evaluation result of the UL transmission; and communicate, based on the UL muting pattern and the evaluation result, the UL transmission to the network entity.

In an aspect of the disclosure, a method, a computer-readable medium, and an apparatus are provided for wireless communication at a first network entity. The apparatus may include memory and at least one processor coupled to the memory. Based at least in part on information stored in the memory, the at least one processor may be configured to transmit, to a UE, a UL muting indication including a UL muting pattern; and receive, based on the UL muting pattern and a UL muting condition associated with a UL transmission, the UL transmission from the UE.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIGS. 4A, 4B, 4C, and 4D illustrate various modes of full duplex communication.

FIG. 5 illustrates examples of in-band full-duplex (IBFD) and sub-band frequency divisional duplex resources.

FIG. 6 is a diagram illustrating an example sub-band full-duplex (SBFD) operation.

FIG. 7 is a diagram illustrating an example co-channel interference.

FIG. 8 is a diagram illustrating example interference mitigations.

FIG. 9 is a diagram illustrating example UL muting during a CLI measurement.

FIG. 10 is a call flow diagram illustrating a method of wireless communication in accordance with various aspects of the present disclosure.

FIG. 11 is a flowchart illustrating methods of wireless communication at a network entity in accordance with various aspects of the present disclosure.

FIG. 12 is a flowchart illustrating methods of wireless communication at a network entity in accordance with various aspects of the present disclosure.

FIG. 13 is a flowchart illustrating methods of wireless communication at a UE in accordance with various aspects of the present disclosure.

FIG. 14 is a flowchart illustrating methods of wireless communication at a UE in accordance with various aspects of the present disclosure.

FIG. 15 is a flowchart illustrating methods of wireless communication at a network entity in accordance with various aspects of the present disclosure.

FIG. 16 is a flowchart illustrating methods of wireless communication at a network entity in accordance with various aspects of the present disclosure.

FIG. 17 is a diagram illustrating an example of a hardware implementation for an example apparatus and/or network entity.

FIG. 18 is a diagram illustrating an example of a hardware implementation for an example network entity.

### DETAILED DESCRIPTION

Various aspects relate generally to communication system. Some aspects more specifically relate to the UL muting pattern and UL conditional UL muting in wireless communication. In some examples, a first network entity may receive, from a second network entity, a UL muting indication including a UL muting pattern for a CLI measurement related to the first network entity and the second network entity; and indicate, to one or more UEs, the UL muting pattern for the one or more UEs to restrict first UL transmission to the first network entity based on the UL muting pattern. In some examples, a UE may receive, from a network entity, a UL muting indication including a UL muting pattern; evaluate a UL muting condition associated with a UL transmission to obtain an evaluation result of the UL transmission; and communicate, based on the UL muting pattern and the evaluation result, the UL transmission to the network entity.

Particular aspects of the subject matter described in this disclosure can be implemented to realize one or more of the following potential advantages. In some examples, by receiving a UL muting indication including a UL muting pattern from another second network entity; and indicating, to one or more UEs, the UL muting pattern for the one or more UEs to restrict first UL transmission, the described techniques can be used to share or exchange UL muting patterns among multiple network entities for them indicate to their own UEs to avoid UL transmission on the muted time and frequency resources. In some examples, by communicating the UL transmission to the network entity based on the UL muting pattern and the evaluation result associated with a UL muting condition, the described techniques allow the muted time and frequency resources to be configurable based on various conditions. The method reduces the interferences during the measurement and transmission and improves the efficiency of wireless communication.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

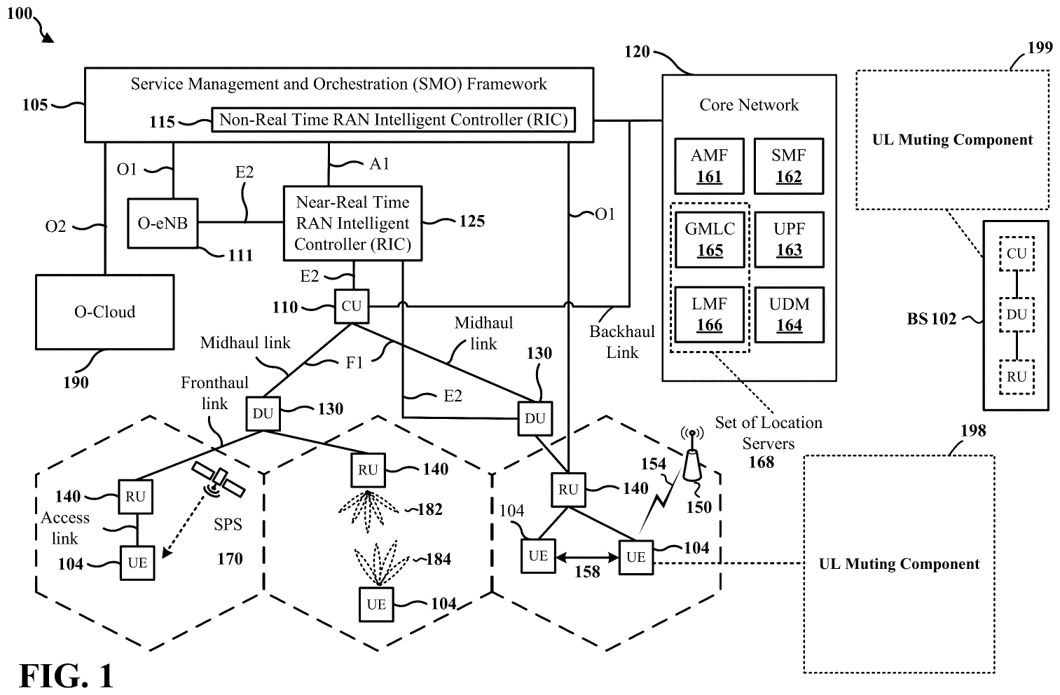

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/ UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a UL muting component 198. The UL muting component 198 may be configured to receive, from a network entity, a UL muting indication including a UL muting pattern; evaluate a UL muting condition associated with a UL transmission to obtain an evaluation result of the UL transmission; and communicate, based on the UL muting pattern and the evaluation result, the UL transmission to the network entity. In certain aspects, the base station 102 may include a UL muting component 199. In some aspects, the UL muting component 199 may be configured to receive, from a second network entity, a UL muting indication including a UL muting pattern for a CLI measurement related to the first network entity and the second network entity; and indicate, to one or more UEs, the UL muting pattern for the one or more UEs to restrict first UL transmission to the first network entity based on the UL muting pattern. In some aspects, the UL muting component 199 may be configured to transmit, to a UE, a UL muting indication including a UL muting pattern; and receive, based on the UL muting pattern and a UL muting condition associated with a UL transmission, the UL transmission from the UE. Although the following description may be focused on 5G NR, the concepts described herein may be applicable to other similar areas, such as LTE, LTE-A, CDMA, GSM, and other wireless technologies.

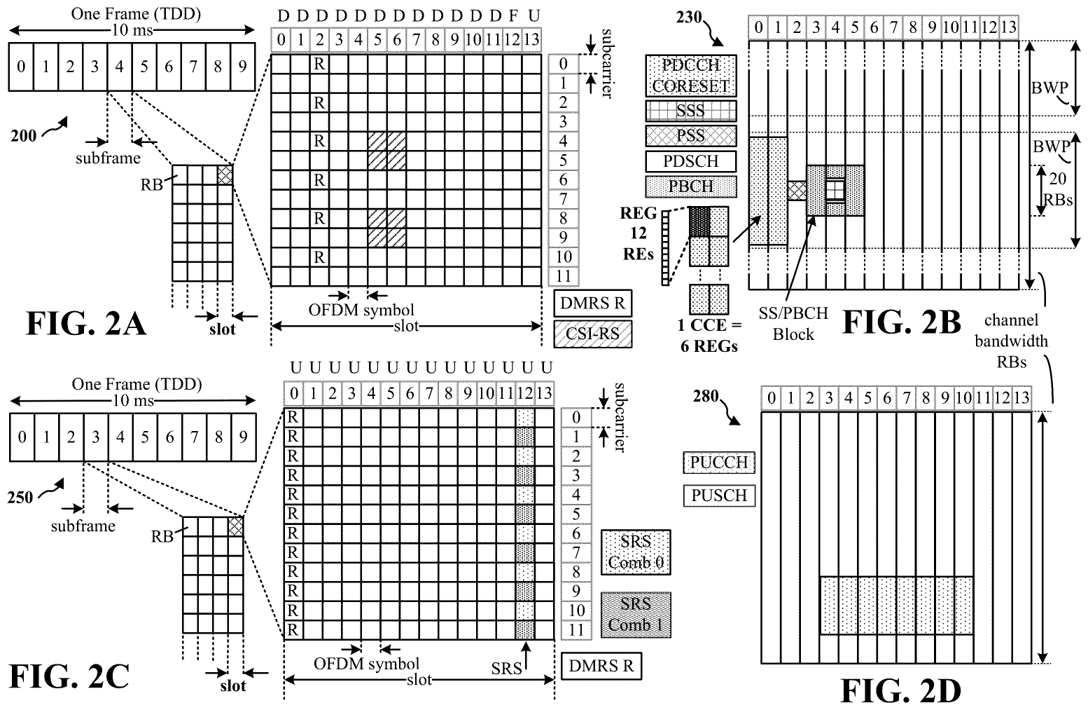

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 24^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

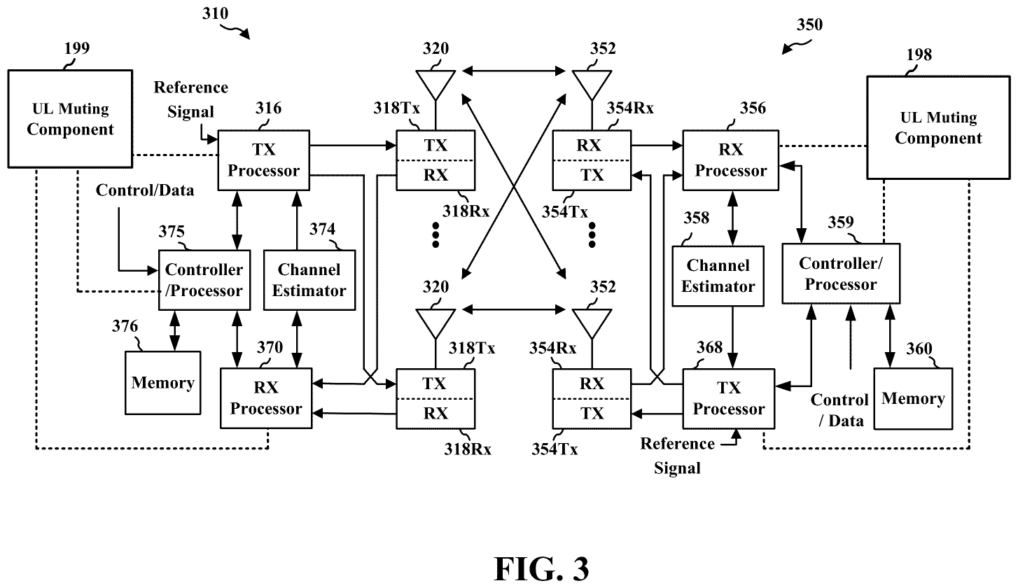

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the UL muting component 198 of FIG. 1.

At least one of the TX processor 316, the RX processor 370, and the controller/processor 375 may be configured to perform aspects in connection with the UL muting component 199 of FIG. 1.

Wireless communication systems may be configured to share available system resources and provide various telecommunication services (e.g., telephony, video, data, messaging, broadcasts, etc.) based on multiple-access technologies that support communication with multiple users. Full duplex operation, in which a wireless device exchanges uplink and downlink communication that overlaps in time, may enable more efficient use of the wireless spectrum. Full duplex operation may include simultaneous transmission and reception in the same frequency range. In some examples, the frequency range may be an mmW frequency range, e.g., frequency range 2 (FR2). In some examples, the frequency range may be a sub-6 GHz frequency range, e.g., frequency range 1 (FR1). Full duplex communication may reduce latency. For example, full duplex operation may enable a UE to receive a downlink signal in an uplink-only slot, which can reduce the latency for the downlink communication. Full duplex communication may improve spectrum efficiency, e.g., spectrum efficiency per cell or per UE. Full duplex communication may enable more efficient use of wireless resources.

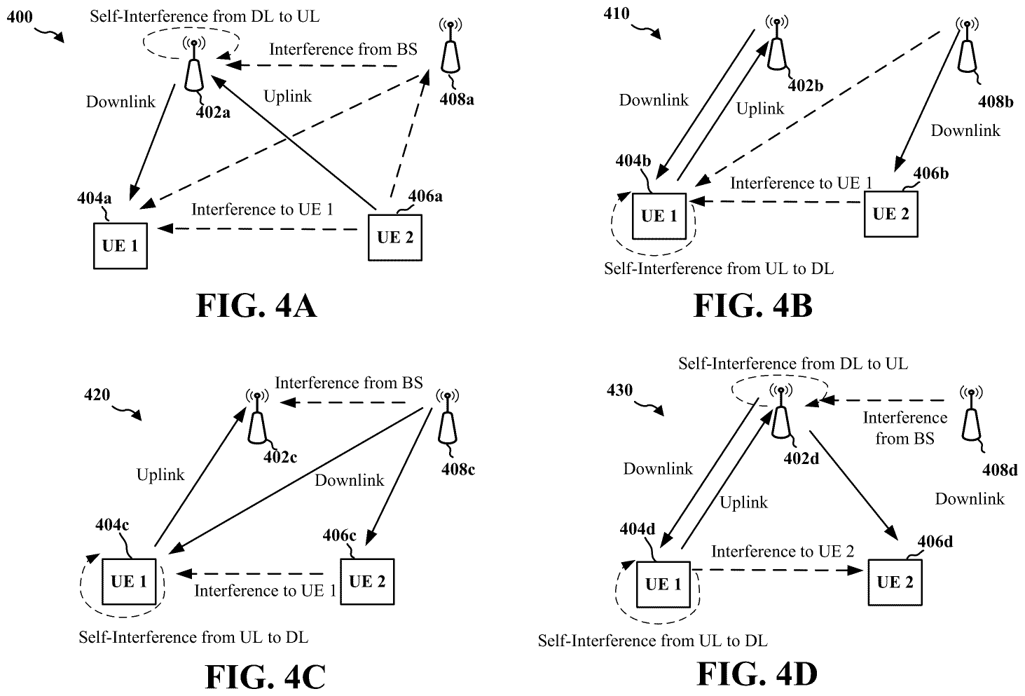

FIGS. 4A, 4B, 4C, and 4D illustrate various modes of full duplex communication. Full duplex communication supports the transmission and reception of information over the same frequency band in a manner that overlaps in time. In this manner, spectral efficiency may be improved with respect to the spectral efficiency of half-duplex communication, which supports the transmission or reception of information in one direction at a time without overlapping uplink and downlink communication. Due to the simultaneous Tx/Rx nature of full duplex communication, a UE or a base station may experience self-interference caused by signal leakage from its local transmitter to its local receiver. In addition, the UE or base station may also experience interference from other devices, such as transmissions from a second UE or a second base station. Such interference (e.g., self-interference or interference caused by other devices) may impact the quality of the communication or even lead to a loss of information.

FIG. 4A shows the first example of full duplex communication 400 in which a first base station 402a is in full duplex communication with a first UE 404a and a second UE 406a. The first UE 404a and the second UE 406a may be configured for half-duplex communication or full-duplex communication. FIG. 4A illustrates the first UE 404a performing downlink reception, and the second UE 406a performing uplink transmission. The second UE 406a may transmit a first uplink signal to the first base station 402a as well as to other base stations, such as a second base station 408a in proximity to the second UE 406a. The first base station 402a transmits a downlink signal to the first UE 404a concurrently (e.g., overlapping at least partially in time) with receiving the uplink signal from the second UE 406a. The base station 402a may experience self-interference at its receiving antenna that is receiving the uplink signal from UE 406a, the self-interference being due to reception of at least part of the downlink signal transmitted to the UE 404a. The base station 402a may experience additional interference due to signals from the second base station 408a. Interference may also occur at the first UE 404a based on signals from the second base station 408a as well as from uplink signals from the second UE 406a.

FIG. 4B shows the second example of full-duplex communication 410 in which a first base station 402b is in full-duplex communication with a first UE 404b. In this example, the UE 404b is also operating in a full-duplex mode. The first base station 402b and the UE 404b receive and transmit communication that overlaps in time and is in the same frequency band. The base station and the UE may each experience self-interference, due to a transmitted signal from the device leaking to (e.g., being received by) a receiver at the same device. The first UE 404b may experience additional interference based on one or more signals emitted from a second UE 406b and/or a second base station 408b in proximity to the first UE 404b.

FIG. 4C shows the third example of full-duplex communication 420 in which a first UE 404c transmits and receives full-duplex communication with a first base station 402c and a second base station 408c. The first base station 402c and the second base station 408c may serve as multiple transmission and reception points (multi-TRPs) for UL and DL communication with the UE 404c. The second base station 408c may also exchange communication with a second UE 406c. In FIG. 4C, the first UE 404c may transmit an uplink signal to the first base station 402c that overlaps in time with receiving a downlink signal from the second base station 408c. The first UE 404c may experience self-interference as a result of receiving at least a portion of the first signal when receiving the second signal, e.g., the UE's uplink signal to the base station 402c may leak to (e.g., be received by) the UE's receiver when the UE is attempting to receive the signal from the other base station 408c. The first UE 404c may experience additional interference from the second UE 406c.

FIG. 4D shows the fourth example of full-duplex communication 430 in which a first base station 402d employs full-duplex communication with a first UE 404d, and transmits downlink communication to a second UE 406d. In this example, the first UE 404d is operating in a full-duplex mode, and the second UE 406d is operating in a half-duplex mode. The first base station 402d and the first UE 404d receive and transmit communication that overlaps in time and is in the same frequency band. The base station 402d and the first UE 404d may each experience self-interference, due to a transmitted signal from the corresponding device leaking to (e.g., being received by) a receiver at the same device. The base station 402d may further experience cross link interference due to a signal transmitted by the base station 408d. The second UE 406d may experience cross-link interference from the uplink transmission of the first UE 404b when receiving downlink communication from the base station 402d.

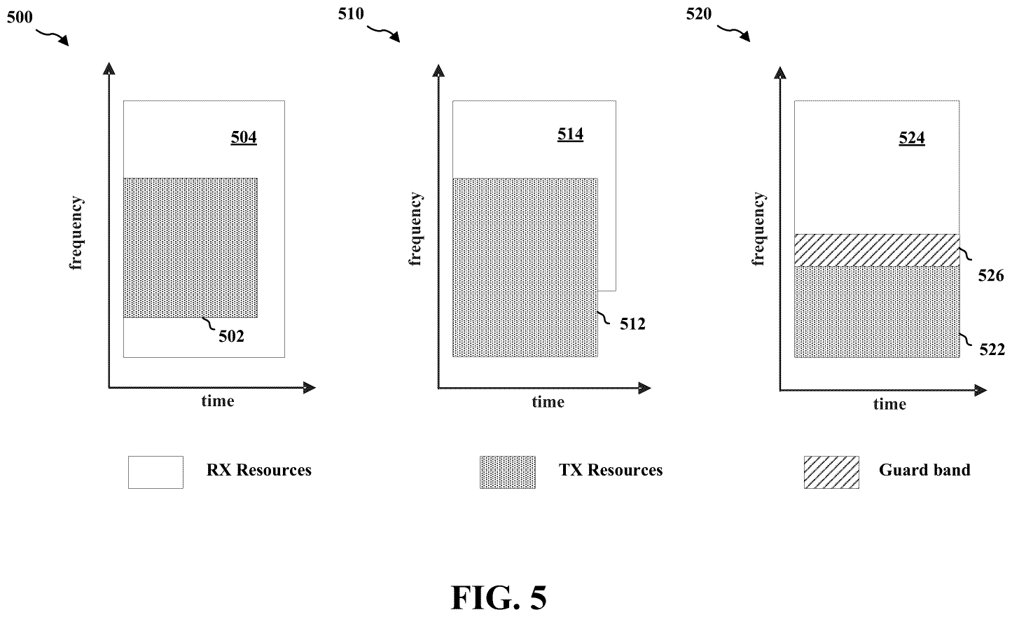

Full duplex communication may be in the same frequency band. The uplink and downlink communication may be in different frequency sub-bands, in the same frequency sub-band, or in partially overlapping frequency sub-bands. FIG. 5 illustrates a first example 500 and a second example 510 of in-band full-duplex (IBFD) resources and a third example 520 of sub-band full-duplex (SBFD) resources. In IBFD, signals may be transmitted and received in overlapping times and overlapping in frequency. As shown in the first example 500, a time and a frequency allocation of transmission resources 502 may fully overlap with a time and a frequency allocation of reception resources 504. In the second example 510, a time and a frequency allocation of transmission resources 512 may partially overlap with a time and a frequency of allocation of reception resources 514.

IBFD is in contrast to sub-band FDD, where transmission and reception resources may overlap in time using different frequencies, as shown in the third example 520. In the third example 520, the UL, the transmission resources 522 are separated from the reception resources 524 by a guard band 526. The guard band may be frequency resources, or a gap in frequency resources, provided between the transmission resources 522 and the reception resources 524. Separating the transmission frequency resources and the reception frequency resources with a guard band may help to reduce self-interference. Transmission resources and reception resources that are immediately adjacent to each other may be considered as having a guard band width of 0. As an output signal from a wireless device may extend outside the transmission resources, the guard band may reduce interference experienced by the wireless device. Sub-band FDD may also be referred to as “flexible duplex”.

If the full-duplex operation is for a UE or a device implementing UE functionality, the transmission resources 502, 512, and 522 may correspond to uplink resources, and the reception resources 504, 514, and 524 may correspond to downlink resources. Alternatively, if the full-duplex operation is for a base station or a device implementing base station functionality, the transmission resources 502, 512, and 522 may correspond to downlink resources, and the reception resources 504, 514, and 524 may correspond to uplink resources.

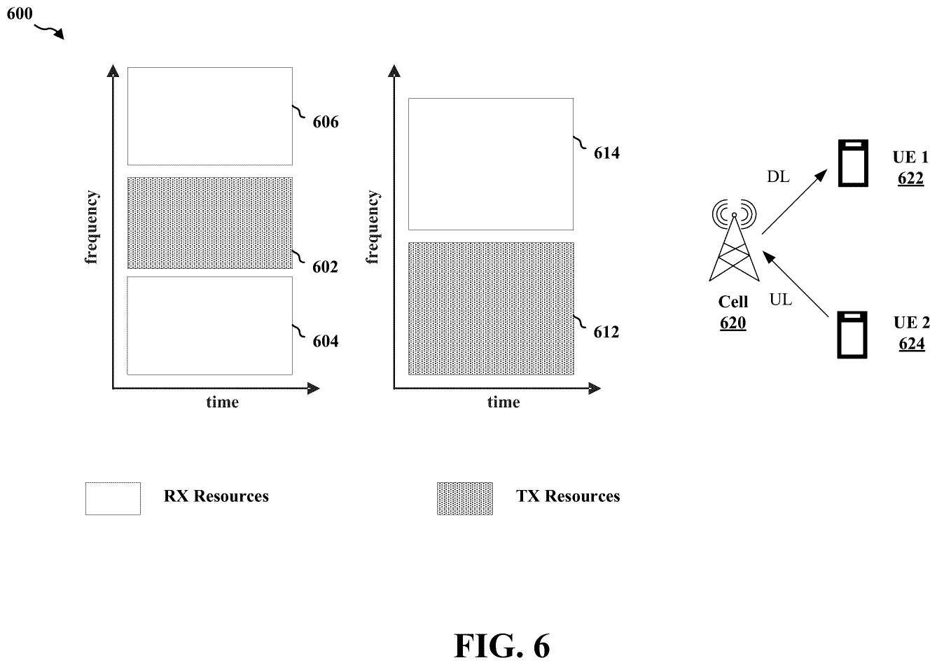

SBFD supports simultaneous Tx/Rx of DL/UL on a sub-band basis. SBFD may increase the UL duty cycle, leading to latency reduction and improvement in UL coverage. For example, under SBFD, a UL signal may be transmitted in DL slots or flexible slots, and a DL signal may be received in UL slots, leading to latency savings. SBFD may enhance the system capacity, resource utilization, spectrum efficiency, and enable flexible and dynamic UL/DL resource adaption according to UL/DL traffic in a robust manner. FIG. 6 is a diagram 600 illustrating an example SBFD operation. As shown in FIG. 6, a cell 620 may have DL communication with one UE (e.g., UE 1 622), and simultaneously have UL communication with another UE (e.g., UE 2 624) on the same slot. In one example, the DL communication with UE 1 622 may utilize RX resources 604, 606, and the UL communication with UE 2 624 may utilize TX resources 602. In another example, the DL communication with UE 1 622 may utilize RX resources 614, and the UL communication with UE 2 624 may utilize TX resources 612.

Uplink resources muting (e.g., restricting the UL transmission for a certain time-domain and/or frequency-domain resources) may facilitate co-channel Cross-Link Interference (CLI) measurement between the cells. The uplink resource muting involved in the CLI measurements may be UE transparent (i.e., does not need any action or configuration from the UE) or non-UE transparent (i.e., may need certain action or configuration from the UE) schemes.

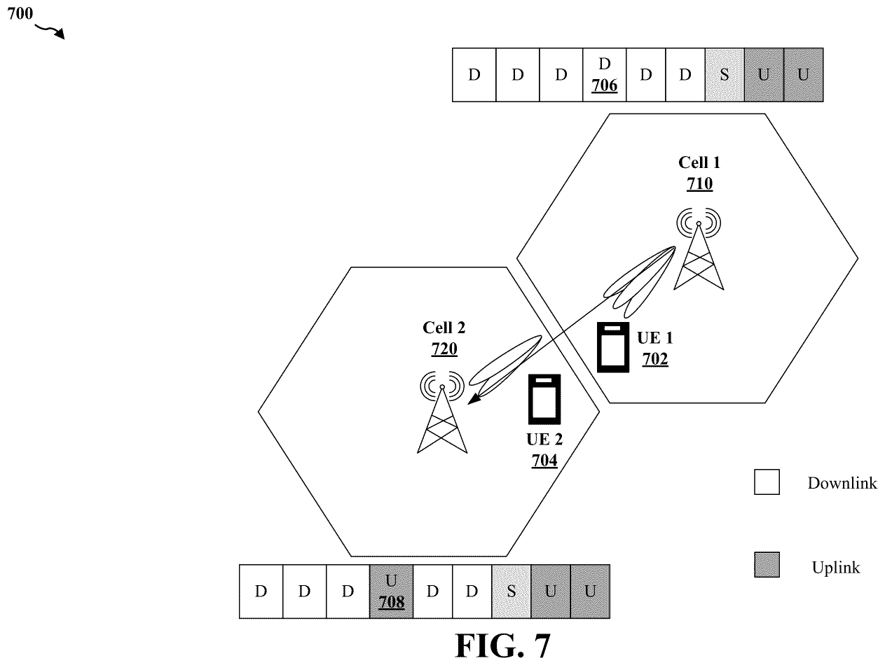

FIG. 7 is a diagram 700 illustrating an example co-channel interference. As shown in FIG. 7, a first cell 710 may be transmitting to a first UE (e.g., UE 1 702) via the slot 706, and a neighbor cell (e.g., cell 720) may be receiving from its own UE (e.g., UE 2 704) via slot 708. A DL to UL cross-link interference exists between cell 710 and cell 720.

Some interference mitigation mechanisms may be adopted to reduce the interferences between the cells. The interference mitigation mechanisms may include receiver beaming forming/nulling or interference cancellation, in which the inter-cell channel may be projected into a null space based on a CLI measurement. To achieve an accurate CLI measurement, the UL transmission within CLI resources may be muted, and the inter-cell channel and interfering (e.g., a cell that causes the interferences) samples for interference cancellation may be provided.

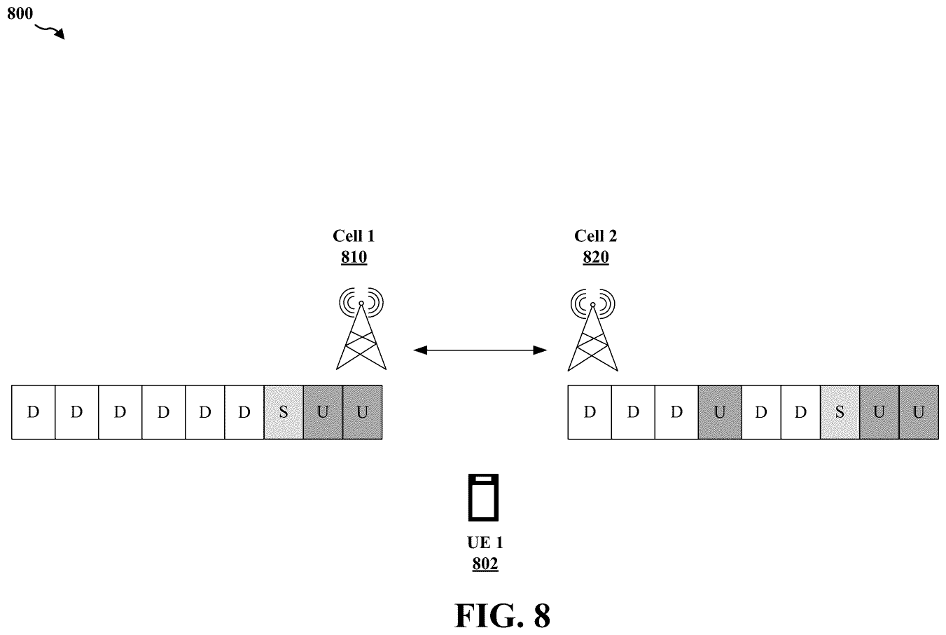

FIG. 8 is a diagram 800 illustrating example interference mitigations. As shown in FIG. 8, when cell 1 810 is transmitting to cell 2 820 for inter-cell CLI measurements, cell 2 820 may mute UL transmission from its UE (e.g., UE 1 802) for CLI measurements.

An interfered cell (e.g., a cell that suffers the interferences and which in some aspects be referred to as a victim cell or a cell that is a victim of interference) may measure the CLI channel to an interfering cell (e.g., a cell that causes the interferences, which may be referred to as an aggressor cell, in some aspects) in order to perform receiver nulling, including beamform nulling and digital interference cancelation. The measured CLI channel may include the channel on each tone (e.g., subcarrier). The interfered cell may estimate the dominant direction/beam in the CLI channel to the interfering cell and find the best combiner (the best combination of RX and TX beams), considering the inter-cell CLI to effectively mitigate the CLI interference.

If the Rx UL signal power is high, the quality of CLI channel measurement may be degraded. To ensure the accuracy of the CLI channel measurement at the interfered cell, the interfered cell may send to its connected UEs a UL-muting indication to prevent the UEs from transmitting UL signals that may interfere with CLI channel measurement.

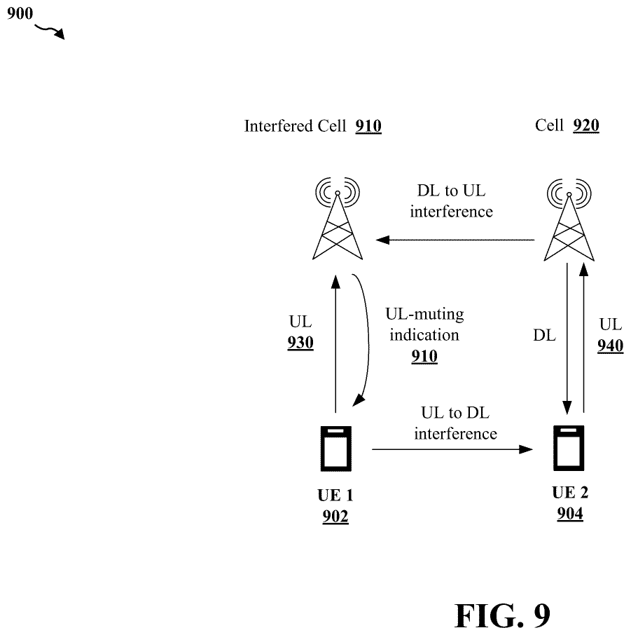

FIG. 9 is a diagram 900 illustrating an example UL muting during a CLI measurement. As shown in FIG. 9, an interfered cell 910 may indicate, at 910, its UE(s) (e.g., UE 1 902) to mute UL transmission 930 in a CLI measurement window to prevent the UE(s) from transmitting UL signals that may interference with the CLI measurement with another cell (e.g., cell 920).

In some examples, UL cancellation indication (ULCI) may be provided to enable a cell to send DCI (e.g., DCI 2_4) to indicate one or more UEs to cancel PUSCH/SRS transmissions in certain time/frequency resources. Since the CLI measurements may be performed periodically, the muting patterns may be periodic or semi-static patterns to reduce the layer 1 (L1)-signaling overhead.

The UL muting pattern indication to a UE served by a measuring cell (or an interfered cell) may enable the measuring cell (or the interfered cell) to measure inter-cell CLI/channel from an interfering cell. However, to have an accurate measurement of inter-cell CLI/channel, neighbor UL UEs in neighbor cells of the interfered cells may avoid UL Tx as well so that the interfered cell will not receive interference from UL UEs of neighbor cells to the interfered cell during the measurement occasions of inter-cell CLI reference signal (RS). For example, referring to FIG. 9, UL (e.g., UL 930) may be muted at UEs (e.g., UE 1 902) of interfered cell 910. In addition, the neighbor cells (e.g., cell 920) may also mute the UL transmission (e.g., UL 940) from its UEs (e.g., UE 2 904) to avoid interference from the neighbor UL UEs (e.g., UE 2 904) to the interfered cell 910 to ensure the interfered cell 910 have an accurate inter-cell CLI/channel measurement.

The present disclosure provides methods and apparatus for exchanging UL muting pattern and UL conditional UL muting pattern among multiple cells. Hence, not only the interfered cell, but also neighbor cells may be aware of the UL muting pattern to ensure accurate inter-cell CLI/channel measurement.

The exchange of the UL muting pattern (or conditional UL muting pattern) may be performed via various mechanisms. In some aspects, the UL muting pattern may be exchanged via backhaul signaling, such as F1 Application Protocol (F1AP) signaling between a DU and a CU, Xn signaling between two CUs, or over-the-air (OTA) signaling between the cells.

In some aspects, the interfered cell may measure the inter-cell CLI in the UL subband of SBFD operation or in wideband (e.g., for dynamic TDD operation). Correspondingly, the UL muting may be configured in the corresponding frequency resources (where the inter-cell CLI is measured).

In some aspects, the muting pattern can be configured as wideband based or subband-based (e.g., at the RE level). The exchanged UL muting pattern can be configured as a semi-static (periodic or semi-persistent) signal, and may be configured as at least one of: time-domain resource pattern (e.g., at the symbol level) or frequency-domain resources pattern (e.g., at the RE level).

In some aspects, the muting pattern may indicate time-domain resource (e.g., symbols) and frequency-domain resources (e.g., at RE level) where UE should cancel its UL transmissions. The UE may be served by the interfered cell or other neighbor cells regarding the muting pattern. The muting pattern may be exchanged over backhaul or OTA signaling. In some aspects, the interfered cell and neighbor cells may use the shared/exchanged UL muting pattern to indicate its own UL UEs to avoid UL transmission on the muted indicated time and frequency resources.

In some aspects, the UL muting may be conditional and UL transmission may be muted when one or more conditions are met or based on an occurrence of one or more conditions. That is, the UE may discard the UL muting indication and its UL transmission will not be affected if one or more of the conditions are not met. The conditional UL muting may reduce the adverse effect the UL muting on the UL performance, especially on prioritized UL transmission.

The conditions on which a UE may discard the UL muting indication and maintain its UL transmission may be set based on various operating conditions or characteristics (e.g., the priority) of the UL transmission. For example, a UE may be configured to discard the UL muting indication if the UL transmission has a high LI priority, the UL transmission is a latency sensitive traffic (e.g., URLLC or extended-reality (XR) transmission), or the UL transmission is a lower MCS UL transmission. For example, the UE may not perform UL muting if the transmission has low MCS since low MCS transmissions would be received by the cell with less power and may not interfere with the cell's CLI RS measurement. Additionally, a UE may discard the UL muting indication if the UL transmission is a lower Tx power. The UE may not perform UL muting, e.g., and may proceed to transmit the UL transmission, if the transmission has lower UL Tx power (e.g., below a threshold) because low UL Tx power transmissions may be received by the cell with less power (or might not be received due to the reduced power) and may not interfere with the cell's CLI RS measurement.

In some aspects, a UE may discard the UL muting indication if the UL transmission is an important UL transmission, e.g., based on a type of transmission, a priority of the transmission, etc. The type of transmission for which the UE may disregard UL muting may be based on any of various operating conditions. For example, a UL transmission for which a UE may disregard a muting indication may include: a failure report through MAC-CE, an ACK or NACK feedback, a PUCCH, an SRS, or a CSI report.

In some aspects, the conditions under which a UE may discard the UL muting indication may be configured for the UEs or may be based on a defined or known rule. In some aspects, the conditions under which a UE may discard the UL muting indication may be indicated by the network, e.g., configured for a cell. For example, a cell may indicate or signal to a UE to skip/cancel the UL muting pattern on certain time/frequency resources.

In some aspects, information related to UEs' conditional UL muting may be exchanged between the cells over F1AP or Xn signaling or OTA signaling. For example, the cells may exchange information regarding which UL muting occasion is valid (and hence the corresponding UL transmission is muted) and which UL muting occasion is not valid (and hence the corresponding UL transmission is not muted) due to, for example, discarding the UL muting indication. In some examples, the UL muting conditions that cause an invalid UL muting may also be exchanged between the cells. In some aspects, based on the information related to the UEs' conditional UL muting, a cell may decide to use or drop the inter-gNB measurement occasion where the UL muting is invalid, and the UL is still transmitted.

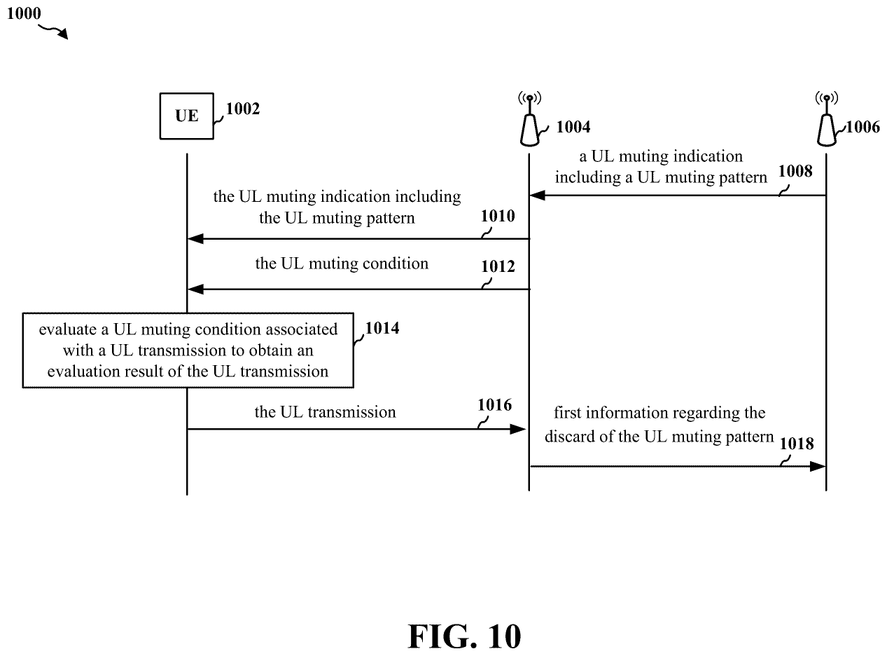

FIG. 10 is a call flow diagram 1000 illustrating a method of wireless communication in accordance with various aspects of this present disclosure. Aspects are described in connection with a first base station 1004 and a second base station 1006 and a UE 1002. For each of the first base station 1004 and the second base station 1006, the aspects may be respectively performed by a base station in aggregation and/or by one or more components of a base station 1004 or 1006 (e.g., such as a CU 110, a DU 130, and/or an RU 140).

As shown in FIG. 10, at 1008, a first base station 1004 may receive from a second base station 1006 a UL muting indication including a UL muting pattern. For example, referring to FIG. 9, the first base station (cell 920) may receive from a second base station 1006 (interfered cell 910) a UL muting indication including a UL muting pattern. Cell 920 may be a neighbor cell of cell 910.

At 1010, the first base station 1004 may transmit to a UE 1002 the UL muting indication including the UL muting pattern. For example, referring to FIG. 9, the first base station (cell 920) may transmit to a UE 904 the UL muting indication including the UL muting pattern.

At 1012, the first base station 1004 may transmit to the UE 1002 the UL muting condition. For example, referring to 9, the first base station (cell 920) may transmit to the UE 904 the UL muting condition.

At 1014, the UE 1002 may evaluate a UL muting condition associated with a UL transmission to obtain an evaluation result of the UL transmission. For example, referring to 9, the UE 904 may evaluate a UL muting condition associated with a UL transmission 940 to obtain an evaluation result of the UL transmission 940.

At 1016, the UE 1002 may communicate with the first base station 1004 the UL transmission based on the UL muting pattern and the evaluation result. For example, referring to FIG. 9, the UE 904 may communicate with the first base station (cell 920) the UL transmission 940 based on the UL muting pattern and the evaluation result.

At 1018, the first base station 1004 may transmit to the second base station 1006 first information regarding the discard of the UL muting pattern of the UE 1002. For example, referring to FIG. 9, the first base station (cell 920) may transmit to the second base station (cell 910) first information regarding the discard of the UL muting pattern of the UE 902. The discard of the UL muting pattern may be related to the UL transmission 940 for a certain inter-cell measurement occasion. In some aspects, cell 910 may decide on whether to use or drop the measurement occasion with unmuted UL transmission based on the first information regarding the discard of the UL muting pattern.

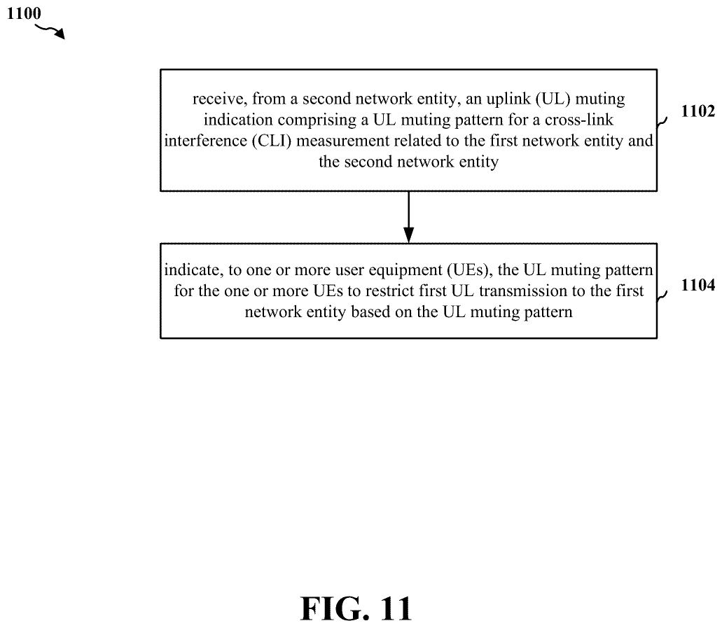

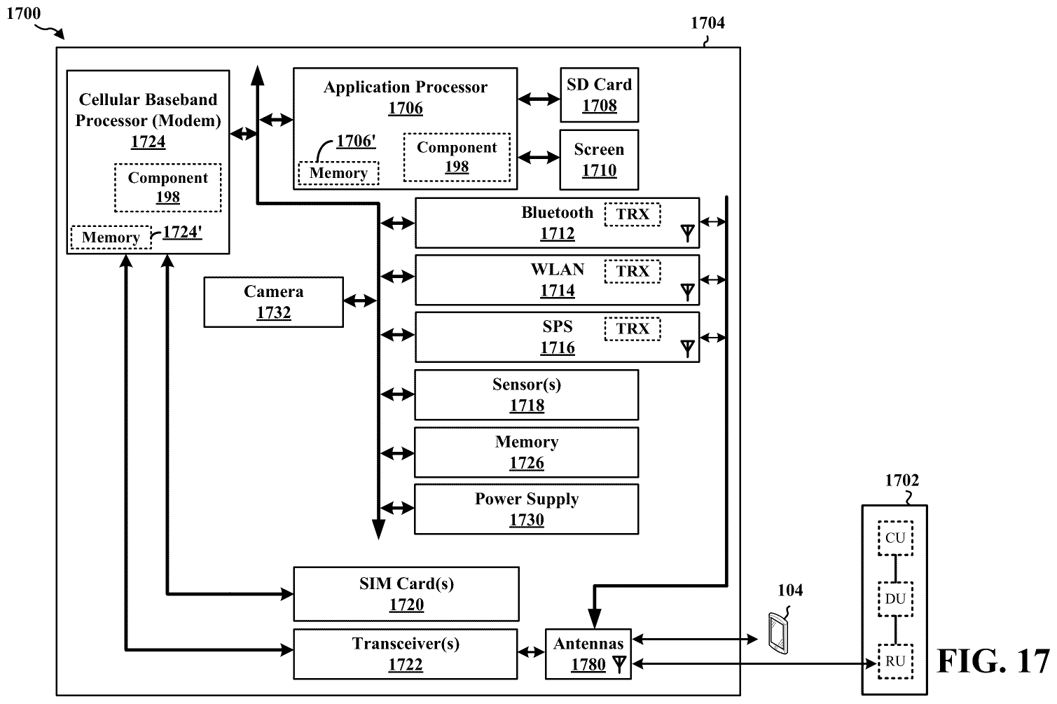

FIG. 11 is a flowchart 1100 illustrating methods of wireless communication at a first network entity in accordance with various aspects of the present disclosure. The method may be performed by the first network entity. The first network entity may be a base station, or a component of a base station, in the access network of FIG. 1 or a core network component (e.g., base station 102, 310, 1004; cell 920; or the network entity 1702 in the hardware implementation of FIG. 17). The method enables the signaling among multiple network entities to share or exchange UL muting patterns to indicate its own UEs to avoid UL transmission on the muted time and frequency resources. The muted time and frequency resources for the UEs may be configurable based on various conditions. The method reduces the interferences during the measurement and transmission and improves the efficiency of wireless communication.

As shown in FIG. 11, at 1102, the first network entity may receive, from a second network entity, a UL muting indication including a UL muting pattern for a CLI measurement related to the first network entity and the second network entity. The second network entity may be a neighbor network entity to the first network entity. For example, the second network entity may be a base station, or a component of a base station, in the access network of FIG. 1 or a core network component (e.g., base station 102, 310, 1006; cell 910; or the network entity 1702 in the hardware implementation of FIG. 17). FIGS. 6, 9, and 10 illustrate various aspects of the steps in connection with flowchart 1100. For example, referring to FIG. 10, the first network entity (base station 1004) may receive, at 1008, from a second network entity (base station 1006), a UL muting indication including a UL muting pattern for a CLI measurement related to the first network entity (base station 1004) and the second network entity (base station 1006). Referring to FIG. 9, the first base station (cell 920) may receive from a second base station 1006 (interfered cell 910) a UL muting indication including a UL muting pattern. In some aspects, 1102 may be performed by the UL muting component 199.

At 1104, the first network entity may indicate, to one or more UEs, the UL muting pattern for the one or more UEs to restrict first UL transmission to the first network entity based on the UL muting pattern. The UE may be the UE 104, 350, 904, 1002, or the apparatus 1704 in the hardware implementation of FIG. 17. For example, referring to FIG. 10, the first network entity (base station 1004) may indicate, at 1010, to one or more UEs (e.g., UE 1002), the UL muting pattern for the one or more UEs (e.g., UE 1002) to restrict first UL transmission to the first network entity (base station 1004) based on the UL muting pattern. Referring to FIG. 9, the first base station (cell 920) may transmit to a UE 904 the UL muting indication including the UL muting pattern. In some aspects, 1104 may be performed by the UL muting component 199.

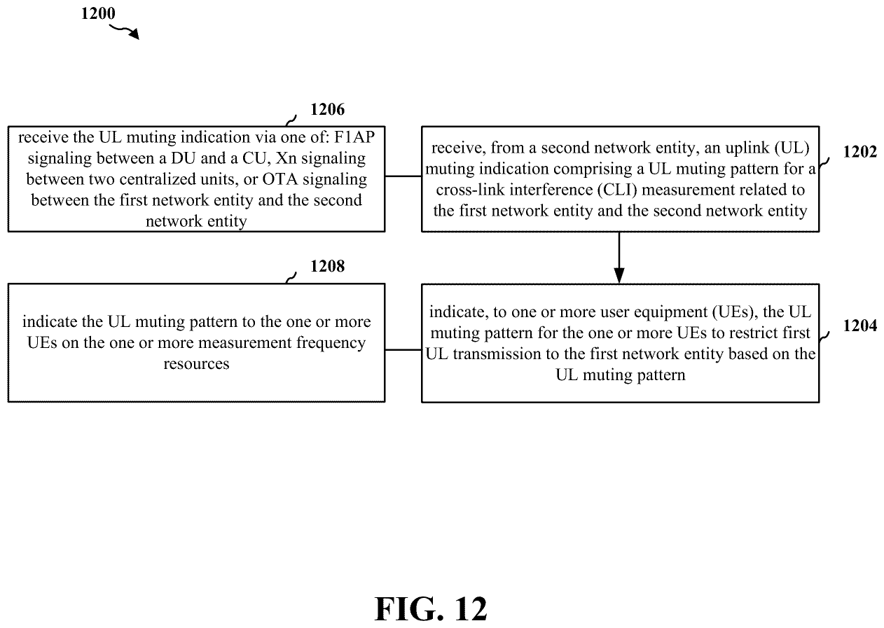

FIG. 12 is a flowchart 1200 illustrating methods of wireless communication at a first network entity in accordance with various aspects of the present disclosure. The method may be performed by the first network entity. The first network entity may be a base station, or a component of a base station, in the access network of FIG. 1 or a core network component (e.g., base station 102, 310, 1004; cell 920; or the network entity 1702 in the hardware implementation of FIG. 17). The method enables the signaling among multiple network entities to share or exchange UL muting patterns to indicate its own UEs to avoid UL transmission on the muted time and frequency resources. The muted time and frequency resources for the UEs may be configurable based on various conditions. The method reduces the interferences during the measurement and transmission and improves the efficiency of wireless communication.

As shown in FIG. 12, at 1202, the first network entity may receive, from a second network entity, a UL muting indication including a UL muting pattern for a CLI measurement related to the first network entity and the second network entity. The second network entity may be a neighbor network entity to the first network entity. For example, the second network entity may be a base station, or a component of a base station, in the access network of FIG. 1 or a core network component (e.g., base station 102, 310, 1006; cell 910; or the network entity 1702 in the hardware implementation of FIG. 17). FIGS. 6, 9, and 10 illustrate various aspects of the steps in connection with flowchart 1200. For example, referring to FIG. 10, the first network entity (base station 1004) may receive, at 1008, from a second network entity (base station 1006), a UL muting indication including a UL muting pattern for a CLI measurement related to the first network entity (base station 1004) and the second network entity (base station 1006). Referring to FIG. 9, the first base station (cell 920) may receive from a second base station 1006 (interfered cell 910) a UL muting indication including a UL muting pattern. In some aspects, 1202 may be performed by the UL muting component 199.

At 1204, the network entity may indicate, to one or more UEs, the UL muting pattern for the one or more UEs to restrict first UL transmission to the first network entity based on the UL muting pattern. The UE may be the UE 104, 350, 904, 1002, or the apparatus 1704 in the hardware implementation of FIG. 17. For example, referring to FIG. 10, the first network entity (base station 1004) may indicate, at 1010, to one or more UEs (e.g., UE 1002), the UL muting pattern for the one or more UEs (e.g., UE 1002) to restrict first UL transmission to the first network entity (base station 1004) based on the UL muting pattern. Referring to FIG. 9, the first base station (cell 920) may transmit to a UE 904 the UL muting indication including the UL muting pattern. In some aspects, 1204 may be performed by the UL muting component 199.

In some aspects, the UL muting indication may be received, at 1206, via one of: F1AP signaling between a DU and a CU, Xn signaling between two centralized units, or OTA signaling between the first network entity and the second network entity. For example, referring to FIG. 10, the UL muting indication may be received, at 1008, via one of: F1AP signaling between a DU and a CU, Xn signaling between two centralized units, or OTA signaling between the first network entity (base station 1004) and the second network entity (base station 1006).

In some aspects, the UL muting pattern may include one or more measurement frequency resources for the CLI measurement, and indicating the UL muting pattern may include, at 1208, indicate the UL muting pattern to the one or more UEs on the one or more measurement frequency resources. For example, referring to FIG. 6, the CLI measurement may be performed on TX resource 602 or 612, and the UL muting pattern may include TX resource 602 or 612.

In some aspects, the CLI measurement may be performed in an SBFD operation, and the one or more measurement frequency resources are one or more subbands associated with the SBFD operation. For example, referring to FIG. 6, the CLI measurement may be performed in an SBFD operation, and the one or more measurement frequency resources are one or more subbands (e.g., TX resources 602, 612) associated with the SBFD operation.

In some aspects, the CLI measurement may be performed on a D-TDD operation, and the one or more measurement frequency resources is one frequency wideband associated with the D-TDD operation. For example, referring to FIG. 9, the CLI measurement of cell 910 may be performed on a D-TDD operation, and the one or more measurement frequency resources (on which the UL transmission is muted for UE 904) may be one frequency wideband associated with the D-TDD operation.

In some aspects, the UL muting pattern may include a periodic or semi-persistent pattern including one or more of: one or more time-domain resources for uplink muting, or one or more frequency-domain resources for the uplink muting. For example, referring to FIG. 10, when the first base station 1004 receives, at 1008, the UL muting indication including a UL muting pattern from the second base station 1006, the UL muting pattern may be configured as periodic or semi-persistent. Referring to FIG. 6, the UL muting pattern may include one or more time-domain resources (e.g., time-domain resources corresponding to resources 602 or 612) for uplink muting, or one or more frequency-domain resources (e.g., frequency-domain resources corresponding to resources 602 or 612) for the uplink muting.

In some aspects, the one or more time-domain resources are one or more symbols, and the one or more frequency-domain resources are one or more REs. For example, referring to FIG. 10, when the first base station 1004 receives, at 1008, the UL muting indication including a UL muting pattern from the second base station 1006, the UL muting pattern may specify one or more symbols and/or one or more REs for the uplink muting of the UE 1002.

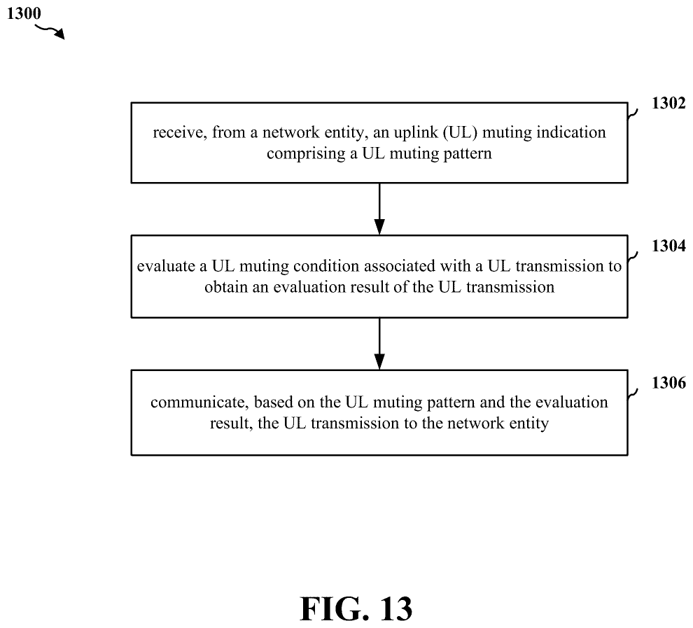

FIG. 13 is a flowchart 1300 illustrating methods of wireless communication at a UE in accordance with various aspects of the present disclosure. The method may be performed by the UE. The UE may be the UE 104, 350, 904, 1002, or the apparatus 1704 in the hardware implementation of FIG. 17. The method enables the signaling among multiple network entities to share or exchange UL muting patterns to indicate its own UEs to avoid UL transmission on the muted time and frequency resources. The muted time and frequency resources for the UEs may be configurable based on various conditions. The method reduces the interferences during the measurement and transmission and improves the efficiency of wireless communication.

As shown in FIG. 13, at 1302, the UE may receive, from a network entity, a UL muting indication including a UL muting pattern. The network entity may be a base station, or a component of a base station, in the access network of FIG. 1 or a core network component (e.g., base station 102, 310, 1004; cell 920; or the network entity 1702 in the hardware implementation of FIG. 17). FIGS. 6, 9, and 10 illustrate various aspects of the steps in connection with flowchart 1300. For example, referring to FIG. 10, the UE 1002 may receive, at 1010, from a network entity (base station 1004), a UL muting indication including a UL muting pattern. Referring to FIG. 9, the UE 904 may receive from a network entity (cell 920), a UL muting indication including a UL muting pattern. In some aspects, 1302 may be performed by the UL muting component 198.

At 1304, the UE may evaluate a UL muting condition associated with a UL transmission to obtain an evaluation result of the UL transmission. For example, referring to FIG. 10, the UE 1002 may evaluate, at 1014, a UL muting condition associated with a UL transmission to obtain an evaluation result of the UL transmission. Referring to FIG. 9, the UE 904 may evaluate a UL muting condition associated with a UL transmission 940 to obtain an evaluation result of the UL transmission 940. In some aspects, 1304 may be performed by the UL muting component 198.

At 1306, the UE may communicate, based on the UL muting pattern and the evaluation result, the UL transmission to the network entity. For example, referring to FIG. 10, the UE 1002 may communicate, at 1016, based on the UL muting pattern and the evaluation result, the UL transmission to the network entity (base station 1004). Referring to FIG. 9, the UE 904 may communicate, based on the UL muting pattern and the evaluation result, the UL transmission 940 to the network entity (cell 920). In some aspects, 1306 may be performed by the UL muting component 198.

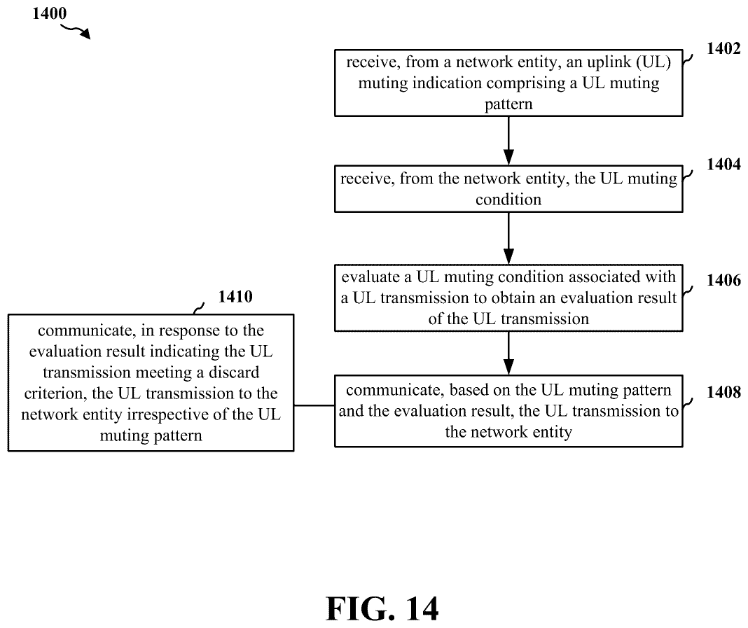

FIG. 14 is a flowchart 1400 illustrating methods of wireless communication at a UE in accordance with various aspects of the present disclosure. The method may be performed by the UE. The UE may be the UE 104, 350, 904, 1002, or the apparatus 1704 in the hardware implementation of FIG. 17. The method enables the signaling among multiple network entities to share or exchange UL muting patterns to indicate its own UEs to avoid UL transmission on the muted time and frequency resources. The muted time and frequency resources for the UEs may be configurable based on various conditions. The method reduces the interferences during the measurement and transmission and improves the efficiency of wireless communication.

As shown in FIG. 14, at 1402, the UE may receive, from a network entity, a UL muting indication including a UL muting pattern. The network entity may be a base station, or a component of a base station, in the access network of FIG. 1 or a core network component (e.g., base station 102, 310, 1004; cell 920; or the network entity 1702 in the hardware implementation of FIG. 17). FIGS. 6, 9, and 10 illustrate various aspects of the steps in connection with flowchart 1400. For example, referring to FIG. 10, the UE 1002 may receive, at 1010, from a network entity (base station 1004), a UL muting indication including a UL muting pattern. Referring to FIG. 9, the UE 904 may receive from a network entity (cell 920), a UL muting indication including a UL muting pattern. In some aspects, 1402 may be performed by the UL muting component 198.

At 1406, the UE may evaluate a UL muting condition associated with a UL transmission to obtain an evaluation result of the UL transmission. For example, referring to FIG. 10, the UE 1002 may evaluate, at 1014, a UL muting condition associated with a UL transmission to obtain an evaluation result of the UL transmission. Referring to FIG. 9, the UE 904 may evaluate a UL muting condition associated with a UL transmission 940 to obtain an evaluation result of the UL transmission 940. In some aspects, 1406 may be performed by the UL muting component 198.

At 1408, the UE may communicate, based on the UL muting pattern and the evaluation result, the UL transmission to the network entity. For example, referring to FIG. 10, the UE 1002 may communicate, at 1016, based on the UL muting pattern and the evaluation result, the UL transmission to the network entity (base station 1004). Referring to FIG. 9, the UE 904 may communicate, based on the UL muting pattern and the evaluation result, the UL transmission 940 to the network entity (cell 920). In some aspects, 1408 may be performed by the UL muting component 198.

In some aspects, the UL muting indication may be associated with a ULCI received from the network entity. For example, referring to FIG. 10, when the UE 1002 receives the UL muting indication from the network entity (base station 1004), the UL muting indication may be associated with a ULCI received from the network entity (base station 1004).

In some aspects, the UL muting pattern may indicate one or more transmission resources not to be utilized by the UE for the UL transmission with the network entity, and the transmission resources may include one or more of: one or more time-domain resources for uplink muting, or one or more frequency-domain resources for the uplink muting. For example, referring to FIG. 10, when the UE 1002 receives, at 1010, the UL muting indication including the UL muting pattern, the UL muting pattern may indicate one or more transmission resources not to be utilized by the UE 1002 for the UL transmission with the network entity (base station 1004). Referring to FIG. 9, the UL muting pattern may indicate one or more transmission resources not to be utilized by the UE 904 for the UL transmission 940 with the network entity (cell 920). Referring to FIG. 6, the transmission resources may include one or more of: one or more time-domain resources (e.g., time-domain resources associated with TX resources 602, 612) for uplink muting, or one or more frequency-domain resources (e.g., frequency-domain resources associated with TX resources 602, 612) for the uplink muting.

In some aspects, the one or more time-domain resources are one or more symbols, and the one or more frequency-domain resources are one or more REs. For example, referring to FIG. 9, the UE 904 may be indicated one or more symbols or one or more REs not to be utilized for the UL transmission 940 with the network entity (cell 920).

In some aspects, to communicate the UL transmission to the network entity, the UE may, at 1410, communicate, in response to the evaluation result indicating the UL transmission meeting a discard criterion, the UL transmission to the network entity irrespective of the UL muting pattern. For example, referring to FIG. 10, when the UE 1002 communicates, at 1016, the UL transmission with the network entity (base station 1004), the UE 1002 may communicate, at 1016, in response to the evaluation result (at 1014) indicating the UL transmission meeting a discard criterion, the UL transmission to the network entity (base station 1004) irrespective of the UL muting pattern (which the UE received at 1010).

In some aspects, the discard criterion may include one or more of: the UL transmission has a priority higher than a priority threshold, the UL transmission has a latency requirement higher than a latency threshold, the UL transmission is associated with a certain traffic type, the UL transmission has an MCS lower than an MCS threshold, or a transmit power of the UL transmission is lower than a power threshold. For example, referring to FIG. 9, the discard criterion may include one or more of: the UL transmission 940 has a priority higher than a priority threshold, the UL transmission 940 has a latency requirement higher than a latency threshold, the UL transmission 940 is associated with a certain traffic type, the UL transmission 940 has an MCS lower than an MCS threshold, or a transmit power of the UL transmission 940 is lower than a power threshold.

In some aspects, the priority threshold, the latency threshold, the certain traffic type, the MCS threshold, and the power threshold may be predefined for the UE or received from the network entity. For example, referring to FIG. 10, the priority threshold, the latency threshold, the certain traffic type, the MCS threshold, and the power threshold may be predefined for the UE 1002 or received from the network entity (base station 1004).

In some aspects, the discard criterion may include: the UL transmission is one of the critical transmissions. The critical transmissions include one or more of: a failure report through MAC-CE, an ACK or NACK feedback, a PUCCH, an SRS, or a CSI report. For example, referring to FIG. 9, the discard criterion may include: the UL transmission 940 is one of the critical transmissions. The critical transmissions may include one or more of: a failure report through MAC-CE, an ACK or NACK feedback, a PUCCH, an SRS, or a CSI report.

In some aspects, the UL muting condition is predefined for the UE. For example, referring to FIG. 10, when the UE 1002 evaluates, at 1014, the UL muting condition, the UL muting condition may be predefined for the UE 1002.

In some aspects, at 1404, the UE may receive the UL muting condition from the network entity. For example, referring to FIG. 10, the UE 1002 may receive, at 1001, the UL muting condition from the network entity (base station 1004). In some aspects, 1404 may be performed by the UL muting component 199.

In some aspects, the UL muting condition indicates discarding the UL muting pattern on at least one of: one or more selected time-domain resources of the UE, or one or more selected frequency-domain resources of the UE. For example, referring to FIG. 6, the UL muting condition may indicate discarding the UL muting pattern on at least one of: one or more selected time-domain resources of the UE (e.g., time-domain resources associated with TX resources 602, 612), or one or more selected frequency-domain resources (e.g., frequency-domain resources associated with TX resources 602, 612) of the UE.

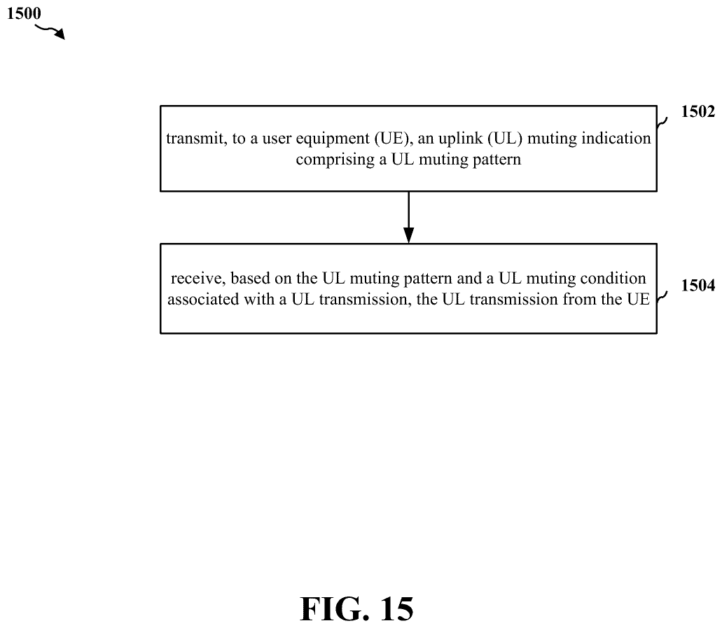

FIG. 15 is a flowchart 1500 illustrating methods of wireless communication at a first network entity in accordance with various aspects of the present disclosure. The method may be performed by the first network entity. The first network entity may be a base station, or a component of a base station, in the access network of FIG. 1 or a core network component (e.g., base station 102, 310, 1004; cell 920; or the network entity 1702 in the hardware implementation of FIG. 17). The method enables the signaling among multiple network entities to share or exchange UL muting patterns to indicate its own UEs to avoid UL transmission on the muted time and frequency resources. The muted time and frequency resources for the UEs may be configurable based on various conditions. The method reduces the interferences during the measurement and transmission and improves the efficiency of wireless communication.

As shown in FIG. 15, at 1502, the first network entity may transmit, to a UE, a UL muting indication including a UL muting pattern. The UE may be the UE 104, 350, 904, 1002, or the apparatus 1704 in the hardware implementation of FIG. 17. FIGS. 6, 9, and 10 illustrate various aspects of the steps in connection with flowchart 1500. For example, referring to FIG. 10, the first network entity (base station 1004) may transmit, at 1010, to a UE 1002, a UL muting indication including a UL muting pattern. In some aspects, 1502 may be performed by the UL muting component 199.

At 1504, the first network entity may receive, based on the UL muting pattern and a UL muting condition associated with a UL transmission, the UL transmission from the UE. For example, referring to FIG. 10, the first network entity (base station 1004) may receive, at 1016, based on the UL muting pattern (at 1010) and a UL muting condition associated with a UL transmission, the UL transmission from the UE 1002. In some aspects, 1504 may be performed by UL muting component 199.

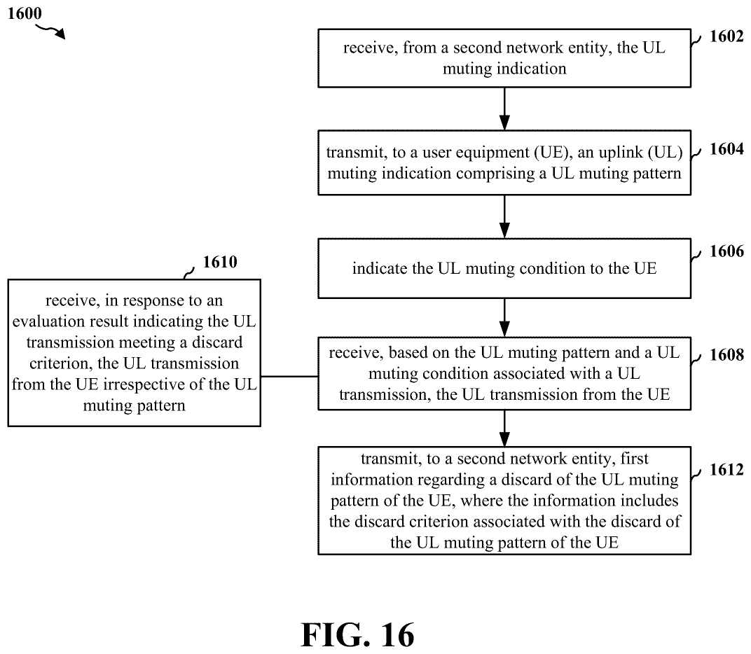

FIG. 16 is a flowchart 1600 illustrating methods of wireless communication at a first network entity in accordance with various aspects of the present disclosure. The method may be performed by the first network entity. The first network entity may be a base station, or a component of a base station, in the access network of FIG. 1 or a core network component (e.g., base station 102, 310, 1004; cell 920; or the network entity 1702 in the hardware implementation of FIG. 17). The method enables the signaling among multiple network entities to share or exchange UL muting patterns to indicate its own UEs to avoid UL transmission on the muted time and frequency resources. The muted time and frequency resources for the UEs may be configurable based on various conditions. The method reduces the interferences during the measurement and transmission and improves the efficiency of wireless communication.

As shown in FIG. 16, at 1604, the first network entity may transmit, to a UE, a UL muting indication including a UL muting pattern. The UE may be the UE 104, 350, 904, 1002, or the apparatus 1704 in the hardware implementation of FIG. 17. FIGS. 6, 9, and 10 illustrate various aspects of the steps in connection with flowchart 1600. For example, referring to FIG. 10, the first network entity (base station 1004) may transmit, at 1010, to a UE 1002, a UL muting indication including a UL muting pattern. In some aspects, 1604 may be performed by the UL muting component 199.

At 1608, the first network entity may receive, based on the UL muting pattern and a UL muting condition associated with a UL transmission, the UL transmission from the UE. For example, referring to FIG. 10, the first network entity (base station 1004) may receive, at 1016, based on the UL muting pattern (at 1010) and a UL muting condition associated with a UL transmission, the UL transmission from the UE 1002. In some aspects, 1608 may be performed by UL muting component 199.

In some aspects, at 1602, prior to being configured to transmit the UL muting indication, the first network entity may receive, from a second network entity, the UL muting indication. The second network entity may be a neighbor network entity to the first network entity. For example, the second network entity may be a base station, or a component of a base station, in the access network of FIG. 1 or a core network component (e.g., base station 102, 310, 1006; cell 910; or the network entity 1702 in the hardware implementation of FIG. 17). For example, referring to FIG. 10, the first network entity (base station 1004) may, prior to transmitting the UL muting indication (at 1010), receive, at 1008, from a second network entity (base station 1006), the UL muting indication. In some aspects, 1602 may be performed by UL muting component 199.

In some aspects, the UL muting indication is associated with a ULCI of the first network entity. For example, referring to FIG. 10, the UL muting indication (at 1010) may be associated with a ULCI of the first network entity (base station 1006).

In some aspects, the UL muting pattern may indicate one or more transmission resources not to be utilized by the UE for the UL transmission with the first network entity, and the transmission resources may include one or more of: one or more time-domain resources for uplink muting, or one or more frequency-domain resources for the uplink muting. For example, referring to FIG. 10, when the UE 1002 receives, at 1010, the UL muting indication including the UL muting pattern, the UL muting pattern may indicate one or more transmission resources not to be utilized by the UE 1002 for the UL transmission with the network entity (base station 1004). Referring to FIG. 9, the UL muting pattern may indicate one or more transmission resources not to be utilized by the UE 904 for the UL transmission 940 with the network entity (cell 920). Referring to FIG. 6, the transmission resources may include one or more of: one or more time-domain resources (e.g., time-domain resources associated with TX resources 602, 612) for uplink muting, or one or more frequency-domain resources (e.g., frequency-domain resources associated with TX resources 602, 612) for the uplink muting.

In some aspects, the one or more time-domain resources are one or more symbols, and the one or more frequency-domain resources are one or more REs. For example, referring to FIG. 9, the UE 904 may be indicated one or more symbols or one or more REs not to be utilized for the UL transmission 940 with the network entity (cell 920).

In some aspects, to receive the UL transmission from the UE, the first network entity may, at 1610, receive, in response to an evaluation result indicating the UL transmission meeting a discard criterion, the UL transmission from the UE irrespective of the UL muting pattern. For example, referring to FIG. 10, when the first network entity (base station 1004) receives, at 1016, the UL transmission from UE 1002, the first entity (base station 1004) may receive, at 1016, in response to the evaluation result (at 1014) indicating the UL transmission meeting a discard criterion, the UL transmission from UE 1002 irrespective of the UL muting pattern (which the UE received at 1010).

In some aspects, at 1612, the first network entity may transmit, to a second network entity, first information regarding a discard of the UL muting pattern of the UE. The information may include the discard criterion associated with the discard of the UL muting pattern of the UE. For example, referring to FIG. 10, the first network entity (base station 1004) may transmit, at 1018, to a second network entity (base station 1006), first information regarding a discard of the UL muting pattern of the UE 1002. The information may include the discard criterion associated with the discard of the UL muting pattern of the UE 1002. In some aspects, 1612 may be performed by the UL muting component 199.

In some aspects, the discard criterion may include one or more of: the UL transmission has a priority higher than a priority threshold, the UL transmission has a latency requirement higher than a latency threshold, the UL transmission is associated with a certain traffic type, the UL transmission has an MCS lower than an MCS threshold, a transmit power of the UL transmission is lower than a power threshold, or the UL transmission is one of the critical transmissions. The critical transmissions may include one or more of: a failure report through MAC-CE, an ACK or NACK feedback, a PUCCH, an SRS, or a CSI report. For example, referring to FIG. 9, the discard criterion may include one or more of: the UL transmission 940 has a priority higher than a priority threshold, the UL transmission 940 has a latency requirement higher than a latency threshold, the UL transmission 940 is associated with a certain traffic type, the UL transmission 940 has an MCS lower than an MCS threshold, or a transmit power of the UL transmission 940 is lower than a power threshold. The discard criterion may further include: the UL transmission 940 is one of the critical transmissions. The critical transmissions may include one or more of: a failure report through MAC-CE, an ACK or NACK feedback, a PUCCH, an SRS, or a CSI report.

In some aspects, the priority threshold, the latency threshold, the certain traffic type, the MCS threshold, and the power threshold are predefined for the UE or indicated to the UE by the first network entity. For example, referring to FIG. 10, the priority threshold, the latency threshold, the certain traffic type, the MCS threshold, and the power threshold may be predefined for the UE 1002 or received from the first network entity (base station 1004).

In some aspects, the UL muting condition may be predefined for the UE. For example, referring to FIG. 10, when the UE 1002 evaluates, at 1014, the UL muting condition, the UL muting condition may be predefined for the UE 1002.

In some aspects, at 1606, the first network entity may indicate the UL muting condition to the UE. For example, referring to FIG. 10, the first network entity (base station 1004) may indicate, at 1012, the UL muting condition to the UE 1002. In some aspects, 1606 may be performed by the UL muting component 199.

In some aspects, the UL muting condition may indicate discarding the UL muting pattern on at least one of: one or more selected time-domain resources of the UE, or one or more selected frequency-domain resources of the UE. For example, referring to FIG. 6, the UL muting condition may indicate discarding the UL muting pattern on at least one of: one or more selected time-domain resources of the UE (e.g., time-domain resources associated with TX resources 602, 612), or one or more selected frequency-domain resources (e.g., frequency-domain resources associated with TX resources 602, 612) of the UE.

FIG. 17 is a diagram 1700 illustrating an example of a hardware implementation for an apparatus 1704. The apparatus 1704 may be a UE, a component of a UE, or may implement UE functionality. In some aspects, the apparatus 1704 may include a cellular baseband processor 1724 (also referred to as a modem) coupled to one or more transceivers 1722 (e.g., cellular RF transceiver). The cellular baseband processor 1724 may include on-chip memory 1724′. In some aspects, the apparatus 1704 may further include one or more subscriber identity modules (SIM) cards 1720 and an application processor 1706 coupled to a secure digital (SD) card 1708 and a screen 1710. The application processor 1706 may include on-chip memory 1706′. In some aspects, the apparatus 1704 may further include a Bluetooth module 1712, a WLAN module 1714, an SPS module 1716 (e.g., GNSS module), one or more sensor modules 1718 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth module 1712, the WLAN module 1714, and the SPS module 1716 may include an on-chip transceiver (TRX) (or in some cases, just a receiver (RX)). The Bluetooth module 1712, the WLAN module 1714, and the SPS module 1716 may include their own dedicated antennas and/or utilize the antennas 1780 for communication. The cellular baseband processor 1724 communicates through the transceiver(s) 1722 via one or more antennas 1780 with the UE 104 and/or with an RU associated with a network entity 1702. The cellular baseband processor 1724 and the application processor 1706 may each include a computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor 1724 and the application processor 1706 are each responsible for general processing, including the execution of software stored on the computer-readable medium/memory. The software, when executed by the cellular baseband processor 1724/application processor 1706, causes the cellular baseband processor 1724/application processor 1706 to perform the various functions described supra. The computer-readable medium/memory may also be used for storing data that is manipulated by the cellular baseband processor 1724/application processor 1706 when executing software. The cellular baseband processor 1724/application processor 1706 may be a component of the UE 350 and may include the memory 360 and/or at least one of the TX processor 368, the RX processor 356, and the controller/processor 359. In one configuration, the apparatus 1704 may be a processor chip (modem and/or application) and include just the cellular baseband processor 1724 and/or the application processor 1706, and in another configuration, the apparatus 1704 may be the entire UE (e.g., see UE 350 of FIG. 3) and include the additional modules of the apparatus 1704.

As discussed supra, the component 198 may be configured to receive, from a network entity, a UL muting indication including a UL muting pattern; evaluate a UL muting condition associated with a UL transmission to obtain an evaluation result of the UL transmission; and communicate, based on the UL muting pattern and the evaluation result, the UL transmission to the network entity. The component 198 may be further configured to perform any of the aspects described in connection with the flowcharts in FIG. 13 and FIG. 14, and/or performed by the UE 1002 in FIG. 10. The component 198 may be within the cellular baseband processor 1724, the application processor 1706, or both the cellular baseband processor 1724 and the application processor 1706. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1704 may include a variety of components configured for various functions. In one configuration, the apparatus 1704, and in particular the cellular baseband processor 1724 and/or the application processor 1706, includes means for receiving, from a network entity, a UL muting indication including a UL muting pattern, means for evaluating a UL muting condition associated with a UL transmission to obtain an evaluation result of the UL transmission, and means for communicating, based on the UL muting pattern and the evaluation result, the UL transmission to the network entity. The apparatus 1704 may further include means for performing any of the aspects described in connection with the flowcharts in FIG. 13 and FIG. 14, and/or aspects performed by the UE 1002 in FIG. 10. The means may be the component 198 of the apparatus 1704 configured to perform the functions recited by the means. As described supra, the apparatus 1704 may include the TX processor 368, the RX processor 356, and the controller/processor 359. As such, in one configuration, the means may be the TX processor 368, the RX processor 356, and/or the controller/processor 359 configured to perform the functions recited by the means.

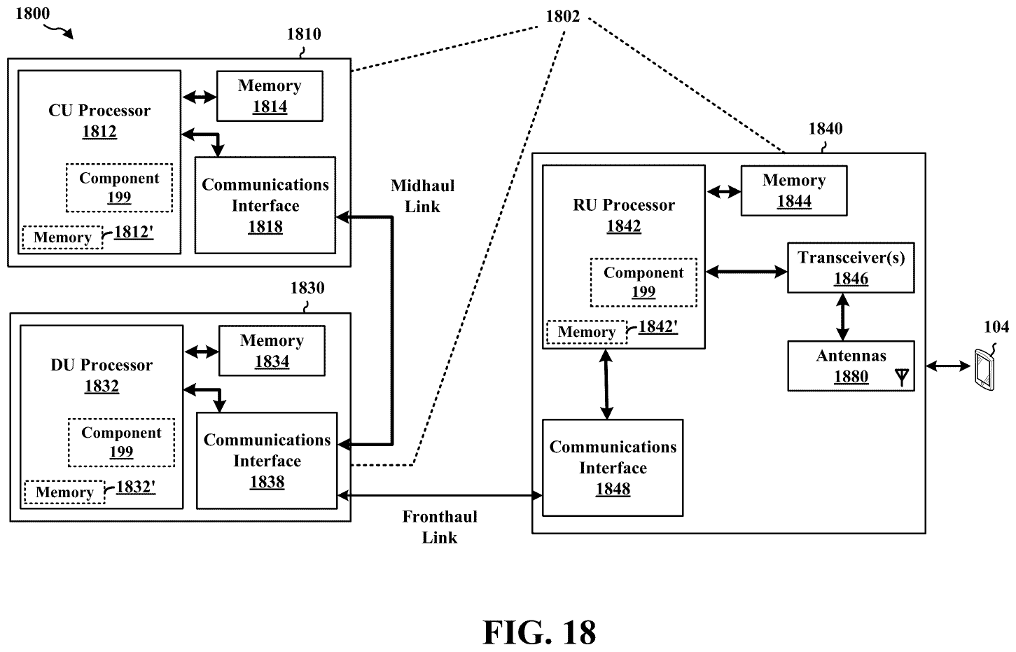

FIG. 18 is a diagram 1800 illustrating an example of a hardware implementation for a network entity 1802. The network entity 1802 may be a BS, a component of a BS, or may implement BS functionality. The network entity 1802 may include at least one of a CU 1810, a DU 1830, or an RU 1840. For example, depending on the layer functionality handled by the component 199, the network entity 1802 may include the CU 1810; both the CU 1810 and the DU 1830; each of the CU 1810, the DU 1830, and the RU 1840; the DU 1830; both the DU 1830 and the RU 1840; or the RU 1840. The CU 1810 may include a CU processor 1812. The CU processor 1812 may include on-chip memory 1812′. In some aspects, the CU 1810 may further include additional memory modules 1814 and a communications interface 1818. The CU 1810 communicates with the DU 1830 through a midhaul link, such as an F1 interface. The DU 1830 may include a DU processor 1832. The DU processor 1832 may include on-chip memory 1832′. In some aspects, the DU 1830 may further include additional memory modules 1834 and a communications interface 1838. The DU 1830 communicates with the RU 1840 through a fronthaul link. The RU 1840 may include an RU processor 1842. The RU processor 1842 may include on-chip memory 1842′. In some aspects, the RU 1840 may further include additional memory modules 1844, one or more transceivers 1846, antennas 1880, and a communications interface 1848. The RU 1840 communicates with the UE 104. The on-chip memory 1812′, 1832′, 1842′ and the additional memory modules 1814, 1834, 1844 may each be considered a computer-readable medium/memory. Each computer-readable medium/memory may be non-transitory. Each of the processors 1812, 1832, 1842 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, in some aspects, the component 199 may be configured to receive, from a second network entity, a UL muting indication including a UL muting pattern for a CLI measurement related to the first network entity and the second network entity; and indicate, to one or more UEs, the UL muting pattern for the one or more UEs to restrict first UL transmission to the first network entity based on the UL muting pattern. In some aspects, the component 199 may be configured to transmit, to a UE, a UL muting indication including a UL muting pattern; and receive, based on the UL muting pattern and a UL muting condition associated with a UL transmission, the UL transmission from the UE. The component 199 may be further configured to perform any of the aspects described in connection with the flowcharts in FIG. 11, FIG. 12, FIG. 15, FIG. 16, and/or performed by the base station 1004 in FIG. 10. The component 199 may be within one or more processors of one or more of the CU 1810, DU 1830, and the RU 1840. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1802 may include a variety of components configured for various functions. In one configuration, the network entity 1802 includes means for receiving, from a second network entity, a UL muting indication including a UL muting pattern for a CLI measurement related to the first network entity and the second network entity, and means for indicating, to one or more UEs, the UL muting pattern for the one or more UEs to restrict first UL transmission to the first network entity based on the UL muting pattern. In some aspects, the network entity 1802 may include means for transmitting, to a UE, a UL muting indication including a UL muting pattern, and means for receiving, based on the UL muting pattern and a UL muting condition associated with a UL transmission, the UL transmission from the UE. The network entity 1802 may further include means for performing any of the aspects described in connection with the flowcharts in FIG. 11, FIG. 12, FIG. 15, FIG. 16, and/or aspects performed by the base station 1004 in FIG. 10. The means may be the component 199 of the network entity 1802 configured to perform the functions recited by the means. As described supra, the network entity 1802 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include receiving, from a network entity, a UL muting indication including a UL muting pattern; evaluating a UL muting condition associated with a UL transmission to obtain an evaluation result of the UL transmission; and communicating, based on the UL muting pattern and the evaluation result, the UL transmission to the network entity. The method enables the signaling among multiple network entities to share or exchange UL muting patterns to indicate its own UEs to avoid UL transmission on the muted time and frequency resources. The muted time and frequency resources for the UEs may be configurable based on various conditions. The method reduces the interferences during the measurement and transmission and improves the efficiency of wireless communication.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a first network entity. The method may include receiving, from a second network entity, a UL muting indication including a UL muting pattern for a CLI measurement related to the first network entity and the second network entity; and indicating, to one or more UEs, the UL muting pattern for the one or more UEs to restrict first UL transmission to the first network entity based on the UL muting pattern.
Aspect 2 is the method of aspect 1, where receiving the UL muting indication may include receiving the UL muting indication via one of: F1AP signaling between a DU and a CU, Xn signaling between two CUs, or OTA signaling between the first network entity and the second network entity.
Aspect 3 is the method of any of aspects 1 to 2, where the UL muting pattern may include one or more measurement frequency resources for the CLI measurement, and indicating the UL muting pattern may include: indicating the UL muting pattern to the one or more UEs on the one or more measurement frequency resources.
Aspect 4 is the method of aspect 3, where the CLI measurement may be performed in an SBFD operation, and the one or more measurement frequency resources may be one or more subbands associated with the SBFD operation.
Aspect 5 is the method of aspect 3, where the CLI measurement may be performed on a D-TDD operation, and the one or more measurement frequency resources may be one frequency wideband associated with the D-TDD operation.
Aspect 6 is the method of any of aspects 1 to 5, where the UL muting pattern may include a periodic or semi-persistent pattern including one or more of: one or more time-domain resources for uplink muting, or one or more frequency-domain resources for the uplink muting.
Aspect 7 is the method of aspect 6, where the one or more time-domain resources may be one or more symbols, and the one or more frequency-domain resources may be one or more REs.
Aspect 8 is an apparatus for wireless communication at a first network entity, including: a memory; and at least one processor coupled to the memory and, based at least in part on information stored in the memory, the at least one processor is configured to perform the method of any of aspects 1-7.
Aspect 9 is the apparatus of aspect 8, further including at least one of a transceiver or an antenna coupled to the at least one processor and configured to receive the UL muting indication.
Aspect 10 is an apparatus for wireless communication including means for implementing the method of any of aspects 1-7.
Aspect 11 is a computer-readable medium (e.g., a non-transitory computer-readable medium) storing computer executable code, where the code when executed by a processor causes the processor to implement the method of any of aspects 1-7.
Aspect 12 is a method of wireless communication at a UE. The method may include receiving, from a network entity, a UL muting indication including a UL muting pattern; evaluating a UL muting condition associated with a UL transmission to obtain an evaluation result of the UL transmission; and communicating, based on the UL muting pattern and the evaluation result, the UL transmission to the network entity.
Aspect 13 is the method of aspect 12, where the UL muting indication may be associated with a ULCI, and the ULCI may be received from the network entity.
Aspect 14 is the method of aspect 12, where the UL muting pattern may indicate one or more transmission resources not to be utilized by the UE for the UL transmission with the network entity, and the transmission resources may include one or more of: one or more time-domain resources for uplink muting, or one or more frequency-domain resources for the uplink muting.
Aspect 15 is the method of aspect 14, where the one or more time-domain resources may be one or more symbols, and the one or more frequency-domain resources may be one or more REs.
Aspect 16 is the method of aspect 13, where communicating the UL transmission to the network entity may include: communicating, in response to the evaluation result indicating the UL transmission meeting a discard criterion, the UL transmission to the network entity irrespective of the UL muting pattern.
Aspect 17 is the method of aspect 16, where the discard criterion may include one or more of: the UL transmission has a priority higher than a priority threshold, the UL transmission has a latency requirement higher than a latency threshold, the UL transmission is associated with a certain traffic type, the UL transmission has a Modulation and Coding Scheme (MCS) lower than an MCS threshold, or the transmit power of the UL transmission is lower than a power threshold.
Aspect 18 is the method of aspect 17, where the priority threshold, the latency threshold, the certain traffic type, the MCS threshold, and the power threshold may be predefined for the UE or received from the network entity.
Aspect 19 is the method of aspect 16, where the discard criterion may include: the UL transmission is one of the critical transmissions. The critical transmissions may include one or more of: a failure report through MAC-CE, an ACK or NACK feedback, a PUCCH, an SRS, or a CSI report.
Aspect 20 is the method of aspect 13, where the UL muting condition may be predefined for the UE.
Aspect 21 is the method of aspect 13, where the method may further include receiving, from the network entity, the UL muting condition.
Aspect 22 is the method of aspect 21, where the UL muting condition may indicate discarding the UL muting pattern on at least one of: one or more selected time-domain resources of the UE, or one or more selected frequency-domain resources of the UE.
Aspect 23 is an apparatus for wireless communication at a UE, including: a memory; and at least one processor coupled to the memory and, based at least in part on information stored in the memory, the at least one processor is configured to perform the method of any of aspects 12-22.
Aspect 24 is the apparatus of aspect 23, further including at least one of a transceiver or an antenna coupled to the at least one processor and configured to communicate the UL transmission to the network entity.
Aspect 25 is an apparatus for wireless communication including means for implementing the method of any of aspects 12-22.
Aspect 26 is a computer-readable medium (e.g., a non-transitory computer-readable medium) storing computer executable code, where the code when executed by a processor causes the processor to implement the method of any of aspects 12-22.
Aspect 27 is a method of wireless communication at a first network entity. The method may include transmitting, to a UE, a UL muting indication including a UL muting pattern; and receiving, based on the UL muting pattern and a UL muting condition associated with a UL transmission, the UL transmission from the UE.
Aspect 28 is the method of aspect 27, where the method may further include, prior to transmitting the UL muting indication, receiving, from a second network entity, the UL muting indication
Aspect 29 is the method of aspect 27, where the UL muting indication may be associated with a ULCI of the first network entity.
Aspect 30 is the method of aspect 27, where the UL muting pattern may indicate one or more transmission resources not to be utilized by the UE for the UL transmission with the first network entity. The transmission resources may include one or more of: one or more time-domain resources for uplink muting, or one or more frequency-domain resources for the uplink muting.
Aspect 31 is the method of aspect 30, where the one or more time-domain resources may be one or more symbols, and the one or more frequency-domain resources may be one or more REs.
Aspect 32 is the method of any of aspects 27 to 31, where receiving the UL transmission from the UE may include: receiving, in response to an evaluation result indicating the UL transmission meeting a discard criterion, the UL transmission from the UE irrespective of the UL muting pattern.
Aspects 33 is the method of aspect 32, where the method may further include transmitting, to a second network entity, first information regarding a discard of the UL muting pattern of the UE. The first information may include the discard criterion associated with the discard of the UL muting pattern of the UE.
Aspect 34 is the method of aspect 32, where the discard criterion may include one or more of: the UL transmission has a priority higher than a priority threshold, the UL transmission has a latency requirement higher than a latency threshold, the UL transmission is associated with a certain traffic type, the UL transmission has an MCS lower than an MCS threshold, a transmit power of the UL transmission is lower than a power threshold, or the UL transmission is one of the critical transmissions. The critical transmissions may include one or more of: a failure report through MAC-CE, an ACK or NACK feedback, a PUCCH, an SRS, or a CSI report.
Aspect 35 is the method of aspect 34, where the priority threshold, the latency threshold, the certain traffic type, the MCS threshold, and the power threshold may be predefined for the UE or indicated to the UE by the first network entity.
Aspect 36 is the method of any of aspects 27 to 35, where the UL muting condition may be predefined for the UE or indicated to the UE by the first network entity.
Aspect 37 is the method of aspect 36, where the UL muting condition may indicate discarding the UL muting pattern on at least one of: one or more selected time-domain resources of the UE, or one or more selected frequency-domain resources of the UE.
Aspect 38 is an apparatus for wireless communication at a first network entity, including: a memory; and at least one processor coupled to the memory and, based at least in part on information stored in the memory, the at least one processor is configured to perform the method of any of aspects 27-37.
Aspect 39 is the apparatus of aspect 38, further including at least one of a transceiver or an antenna coupled to the at least one processor and configured to transmit the UL muting indication.
Aspect 40 is an apparatus for wireless communication including means for implementing the method of any of aspects 27-37.
Aspect 41 is a computer-readable medium (e.g., a non-transitory computer-readable medium) storing computer executable code, where the code when executed by a processor causes the processor to implement the method of any of aspects 27-37.

What is claimed is:

1. An apparatus for wireless communication at a first network entity, comprising:
memory; and
at least one processor coupled to the memory and, based at least in part on information stored in the memory, the at least one processor is configured to:
receive, from a second network entity, an uplink (UL) muting indication comprising a UL muting pattern for a cross-link interference (CLI) measurement related to the first network entity and the second network entity; and
indicate, to one or more user equipment (UEs), the UL muting pattern for the one or more UEs to restrict first UL transmission to the first network entity based on the UL muting pattern.

2. The apparatus of claim 1, further comprising a transceiver coupled to the at least one processor, wherein, to receive the UL muting indication, the at least one processor is configured to receive the UL muting indication via the transceiver, and wherein, to receive the UL muting indication, the at least one processor is configured to receive the UL muting indication via one of:
F1AP signaling between a distributed unit (DU) and a centralized unit (CU),
Xn signaling between two centralized units, or
Over-The-Air (OTA) signaling between the first network entity and the second network entity.

3. The apparatus of claim 1, wherein the UL muting pattern comprises one or more measurement frequency resources for the CLI measurement, and wherein, to indicate the UL muting pattern, the at least one processor is configured to:
indicate the UL muting pattern to the one or more UEs on the one or more measurement frequency resources.

4. The apparatus of claim 3, wherein the CLI measurement is performed in a sub-band full-duplex (SBFD) operation, and the one or more measurement frequency resources are one or more subbands associated with the SBFD operation.

5. The apparatus of claim 3, wherein the CLI measurement is performed on a dynamic time division duplex (D-TDD) operation, and the one or more measurement frequency resources is one frequency wideband associated with the D-TDD operation.

6. The apparatus of claim 1, wherein the UL muting pattern comprises a periodic or semi-persistent pattern comprising one or more of:
one or more time-domain resources for uplink muting, or
one or more frequency-domain resources for the uplink muting.

7. The apparatus of claim 6, wherein the one or more time-domain resources are one or more symbols, and the one or more frequency-domain resources are one or more resource elements (REs).

8. An apparatus for wireless communication at a user equipment (UE), comprising:
memory; and
at least one processor coupled to the memory and, based at least in part on information stored in the memory, the at least one processor is configured to:
receive, from a network entity, an uplink (UL) muting indication comprising a UL muting pattern;
evaluate a UL muting condition associated with a UL transmission to obtain an evaluation result of the UL transmission; and
communicate, based on the UL muting pattern and the evaluation result, the UL transmission to the network entity.

9. The apparatus of claim 8, further comprising a transceiver coupled to the at least one processor, wherein, to receive the UL muting indication, the at least one processor is configured to receive the UL muting indication via the transceiver, and wherein the UL muting indication is associated with a UL cancellation indication (ULCI), wherein the ULCI is received from the network entity.

10. The apparatus of claim 8, wherein the UL muting pattern indicates one or more transmission resources not to be utilized by the UE for the UL transmission with the network entity, and wherein the transmission resources comprise one or more of:
one or more time-domain resources for uplink muting, or
one or more frequency-domain resources for the uplink muting.

11. The apparatus of claim 10, wherein the one or more time-domain resources are one or more symbols, and the one or more frequency-domain resources are one or more resource elements (REs).

12. The apparatus of claim 9, wherein, to communicate the UL transmission to the network entity, the at least one processor is configured to:
communicate, in response to the evaluation result indicating the UL transmission meeting a discard criterion, the UL transmission to the network entity irrespective of the UL muting pattern.

13. The apparatus of claim 12, wherein the discard criterion comprises one or more of:
the UL transmission has a priority higher than a priority threshold,
the UL transmission has a latency requirement higher than a latency threshold,
the UL transmission is associated with a certain traffic type,
the UL transmission has a Modulation and Coding Scheme (MCS) lower than an MCS threshold, or
a transmit power of the UL transmission is lower than a power threshold.

14. The apparatus of claim 13, wherein the priority threshold, the latency threshold, the certain traffic type, the MCS threshold, and the power threshold are predefined for the UE or received from the network entity.

15. The apparatus of claim 12, wherein the discard criterion comprises:
the UL transmission is one of critical transmissions, wherein the critical transmissions include one or more of:
a failure report through Medium Access Control (MAC) Control Element (MAC-CE),
an acknowledge (ACK) or negative acknowledge (NACK) feedback,
a Physical uplink control channel (PUCCH),
a sounding reference signal (SRS), or
a channel station information (CSI) report.

16. The apparatus of claim 9, wherein the UL muting condition is predefined for the UE.

17. The apparatus of claim 9, wherein the at least one processor is further configured to:
receive, from the network entity, the UL muting condition.

18. The apparatus of claim 17, wherein the UL muting condition indicates discarding the UL muting pattern on at least one of:
one or more selected time-domain resources of the UE, or
one or more selected frequency-domain resources of the UE.

19. An apparatus for wireless communication at a first network entity, comprising:
memory; and
at least one processor coupled to the memory and, based at least in part on information stored in the memory, the at least one processor is configured to:
transmit, to a user equipment (UE), an uplink (UL) muting indication comprising a UL muting pattern; and
receive, based on the UL muting pattern and a UL muting condition associated with a UL transmission, the UL transmission from the UE.

20. The apparatus of claim 19, further comprising a transceiver coupled to the at least one processor, wherein, to transmit the UL muting indication, the at least one processor is configured to transmit the UL muting indication via the transceiver, and wherein the at least one processor is further configured to, prior to being configured to transmit the UL muting indication:
receive, from a second network entity, the UL muting indication.

21. The apparatus of claim 19, wherein the UL muting indication is associated with a UL cancellation indication (ULCI) of the first network entity.

22. The apparatus of claim 19, wherein the UL muting pattern indicates one or more transmission resources not to be utilized by the UE for the UL transmission with the first network entity, and wherein the transmission resources comprise one or more of:
one or more time-domain resources for uplink muting, or
one or more frequency-domain resources for the uplink muting.

23. The apparatus of claim 22, wherein the one or more time-domain resources are one or more symbols, and the one or more frequency-domain resources are one or more resource elements (REs).

24. The apparatus of claim 19, wherein, to receive the UL transmission from the UE, the at least one processor is configured to:
receive, in response to an evaluation result indicating the UL transmission meeting a discard criterion, the UL transmission from the UE irrespective of the UL muting pattern.

25. The apparatus of claim 24, further comprising:
transmitting, to a second network entity, first information regarding a discard of the UL muting pattern of the UE, wherein the first information comprises the discard criterion associated with the discard of the UL muting pattern of the UE.

26. The apparatus of claim 24, wherein the discard criterion comprises one or more of:
the UL transmission has a priority higher than a priority threshold,
the UL transmission has a latency requirement higher than a latency threshold,
the UL transmission is associated with a certain traffic type,
the UL transmission has a Modulation and Coding Scheme (MCS) lower than an MCS threshold,
a transmit power of the UL transmission is lower than a power threshold, or
the UL transmission is one of critical transmissions, wherein the critical transmissions include one or more of:
a failure report through Medium Access Control (MAC) Control Element (MAC-CE),
an acknowledge (ACK) or negative acknowledge (NACK) feedback,
a Physical uplink control channel (PUCCH),
a sounding reference signal (SRS), or
a channel station information (CSI) report.

27. The apparatus of claim 26, wherein the priority threshold, the latency threshold, the certain traffic type, the MCS threshold, and the power threshold are predefined for the UE or indicated to the UE by the first network entity.

28. The apparatus of claim 19, wherein the UL muting condition is predefined for the UE or indicated to the UE by the first network entity.

29. The apparatus of claim 28, wherein the UL muting condition indicates discarding the UL muting pattern on at least one of:
one or more selected time-domain resources of the UE, or
one or more selected frequency-domain resources of the UE.

30. A method of wireless communication at a first network entity, comprising:
receiving, from a second network entity, an uplink (UL) muting indication comprising a UL muting pattern for a cross-link interference (CLI) measurement related to the first network entity and the second network entity; and
indicating, to one or more user equipment (UEs), the UL muting pattern for the one or more UEs to restrict first UL transmission to the first network entity based on the UL muting pattern.
